(19) United States
(12) Patent Application Publication
(10) Pub. No.: US 2024/0114456 A1
(43) Pub. Date: Apr. 4, 2024

(54) METHODS FOR TARGETED WAKE-UP AND 802.11 FRAME ENHANCEMENTS FOR ENERGY HARVESTING

(71) Applicant: INTERDIGITAL PATENT HOLDINGS, INC., Wilmington, DE (US)

(72) Inventors: Nagi Mahalingam, San Diego, CA (US); Hussain Elkotby, Conshohocken, PA (US); Ravikumar Pragada, Warrington, PA (US); Tanbir Haque, Jackson Heights, NY (US); Vikas Gulati, Milpitas, CA (US)

(73) Assignee: INTERDIGITAL PATENT HOLDINGS, INC., Wilmington, DE (US)

(21) Appl. No.: 18/276,089

(22) PCT Filed: Feb. 8, 2022
(86) PCT No.: PCT/US2022/015625

§ 371 Date: Aug. 7, 2023

Related U.S. Application Data
(60) Provisional application No. 63/147,019, filed on Feb. 8, 2021.

(51) Int. Cl. H04W 52/02; H04B 17/318

(52) U.S. Cl. CPC H04W 52/0235; H04B 17/328; H04W 52/0229; H04W 52/0245

(57) ABSTRACT

Methods and apparatus for targeted wake-up and frame enhancement for energy harvesting are disclosed. In one embodiment, a method performed by a station (STA) may compromise: receiving, during an energy detection state, a zero energy (ZE) frame from an access point (AP) that indicates a presence of an energy harvesting (EH) window; harvesting energy for a determined time duration during the EH window; and receiving, during an information decoding state, a data portion of the ZE frame based on a current stored energy of the STA being above a first threshold and a signal strength of the received ZE frame being above a second threshold.

### CROSS-REFERENCE TO RELATED APPLICATIONS

This application claims the benefit of U.S. Provisional Application No. 63/147,019, filed Feb. 8, 2021, the contents of which are incorporated herein by reference.

### BACKGROUND

Both IEEE and 3GPP have a notion of power-save-mode (PSM) for the end-devices (e.g., STA, WTRU, etc.) that acquire services from an Access Point or a gNB. The nominal procedure in power save mode (PSM) involves the end-devices negotiating with the AP or gNB a sleep cycle, waking up as per pre-negotiated periodicities (or event occurrences), indication of buffered data for reception or transmission upon entering the “wake period”, perform data transmission or data reception during the “wake periods” and resume PSM when there is lull in data transmission or reception. To this effect, a cyclic, finite but long duration of time can be a Wake-up cycle and a portion within that cycle can be considered the “wake period” of the end-user device. When a device is woken up, the duration within the Wake-up cycle the device is “active” would depend on the amount of data pending in queues for reception or transmission. Theoretically, once awake, the end-user device may remain active through the entire duration of the Wake-up cycle. If during the “wake period” there is no indication of pending data for reception/transmission, the end-user device resumes the sleep at the end of the wake period.

One of the primary reasons for PSM is energy conservation. The longer a device can sleep, the longer the standby time of the power source of the end-user device. The device that wakes-up periodically mandatorily does so even through there may be nothing to transmit on the downlink (i.e., towards the end-user device). In other words, the device wakes up for the express purpose of determining whether it has data to receive and the mere act of engaging its receiver results in power consumption, albeit a small amount. The identity of the user-device to which data is destined is indicated by the AP or NB on the wake-up packet. As per the current state of the art, in IEEE 802.11ba, the end-user device must detect the wake-up packet, decode the protocol contents to determine whether a wake-up command is addressed to it specifically. The identity of the end-user device is encoded within the MAC payload. Thus, the end-user device must firstly detect the presence of a valid PHY PDU, decode the entire MAC packet secondly (validate the FCS) and then confirm the presence of its identity in the wake-up packet.

In 3GPP, DRX and eDRX are examples of the methods that enable the PSM mechanism. In IEEE 802.11, the 802.11ba principles of a wake-up receiver is an example of methods specified for PSM. As mentioned earlier, the foremost reason behind PSM is energy conservation. The longer a device can sleep, the longer the standby time of the power source of the end-user device. However, the longer the device is made to sleep, the larger the resultant latency in enabling reception/transmissions.

### SUMMARY

Methods and apparatus for targeted wake-up and frame enhancement for energy harvesting are disclosed. In one embodiment, a method performed by a station (STA) may compromise: receiving, during an energy detection state, a zero energy (ZE) frame from an access point (AP) that indicates a presence of an energy harvesting (EH) window; harvesting energy for a determined time duration during the EH window; and receiving, during an information decoding state, a data portion of the ZE frame based on a current stored energy of the STA being above a first threshold and a signal strength of the received ZE frame being above a second threshold. The method may further compromise, initiating an uplink access attempt with the AP, on a condition that the STA detects a group ID.

The EH window may be indicated by a ZE preamble. The duration of the EH window may be indicated by a signature. The received ZE frame may be a frame intended for another STA. The harvested energy may be used to determine whether the STA has sufficient stored energy to receive the data portion of the ZE frame. The current stored energy may be stored in a capacitor.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an exemplary 802.11ax single and multi-user frame format;

FIG. 3 is an exemplary 802.11ax PPDU format;

FIG. 4 is an exemplary MAC frame containing a wake-up packet;

FIG. 5 is an exemplary 802.11ba wake-up packet;

FIG. 6 is an exemplary 802.11ba wake-up procedure with a WuR;

FIG. 7 is an exemplary wake-up preamble configuration;

FIG. 8 is a graph of theoretical availability space for suitable preambles;

FIG. 9 is an exemplary WuP signature and associated partition;

FIG. 10 are exemplary function specific WuP signatures;

FIG. 11 are various exemplary WuP types;

FIG. 12 is a diagram of exemplary ZE-WuR transmission option from a ZE-WuR AP;

FIG. 13 is a diagram of exemplary ZE-WuR reception option from a ZE-WuR AP;

FIG. 14 is a diagram of exemplary dedicated resources for a multi-tone wake-up;

FIG. 15 is a diagram of exemplary shared resources for a multi-tone wake-up;

FIG. 16 is a diagram of exemplary shared resources for a single tone wake-up;

FIG. 17 is a flow-chart illustrating an exemplary process for resource determination of WuP transmissions;

FIG. 18 are exemplary seed and seed windows for WuP transmissions;

FIG. 19 is a diagram representing response latency and response offset determination;

FIG. 20 is a diagram of an exemplary preamble clip for facilitating ZE-WuR discovery;

FIG. 21 is a diagram of an exemplary discovery packet;

FIG. 22 is a diagram illustrating regions of operation for energy harvesting;

FIG. 23 is a diagram illustrating WUR frame and field lengths;

FIG. 24 is an exemplary frame format with a POW preamble after a WuR sync field;

FIG. 25 is an exemplary frame format with a POW preamble preceding a WuR sync field;

FIG. 26 is diagram illustrating exemplary energy harvesting indications to legacy frames;

FIG. 27 is a diagram illustrating an exemplary energy harvesting state machine;

FIG. 28 is a diagram illustrating an exemplary first frame format for energy harvesting; and

FIG. 29 is a diagram illustrating an exemplary second frame format for energy harvesting;

### DETAILED DESCRIPTION

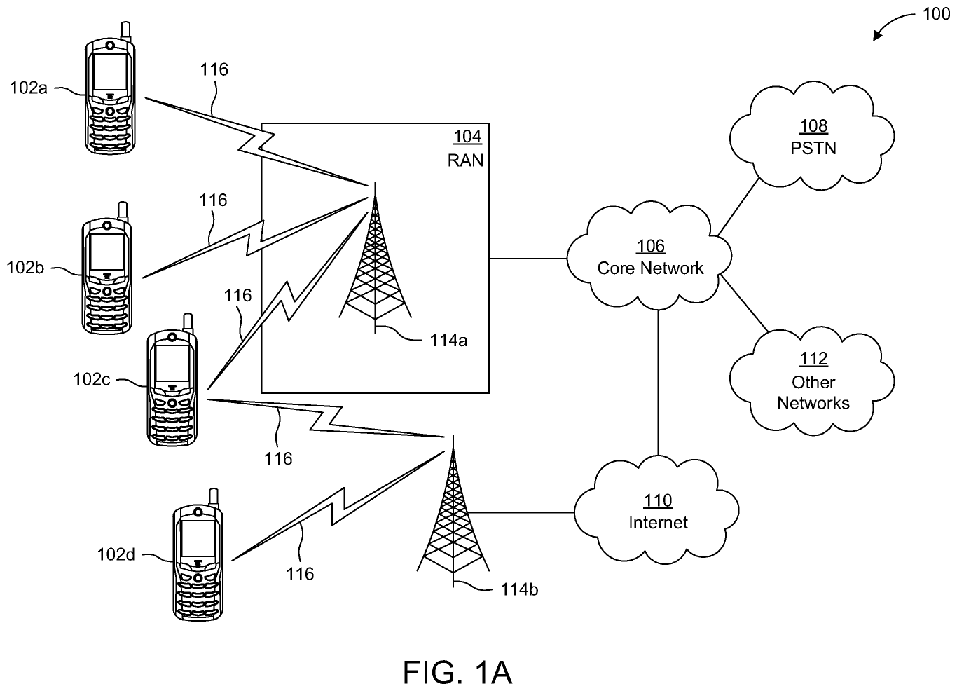

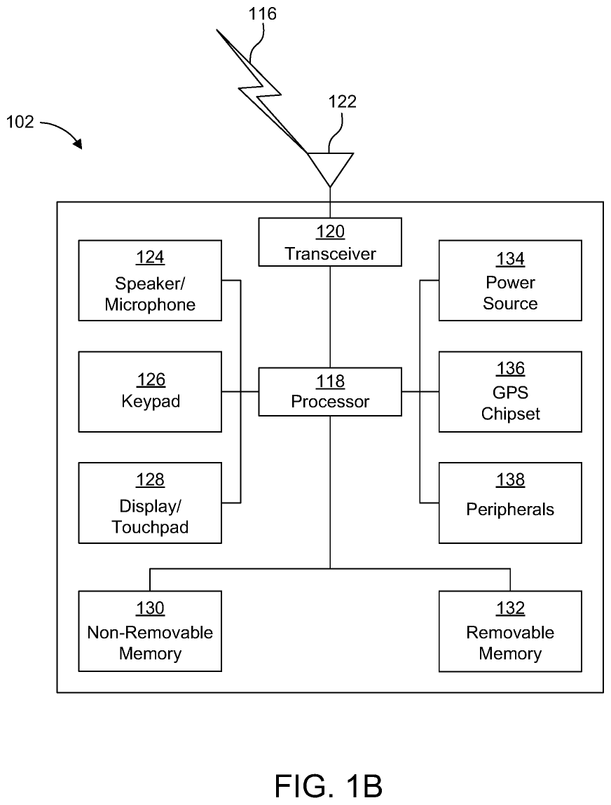

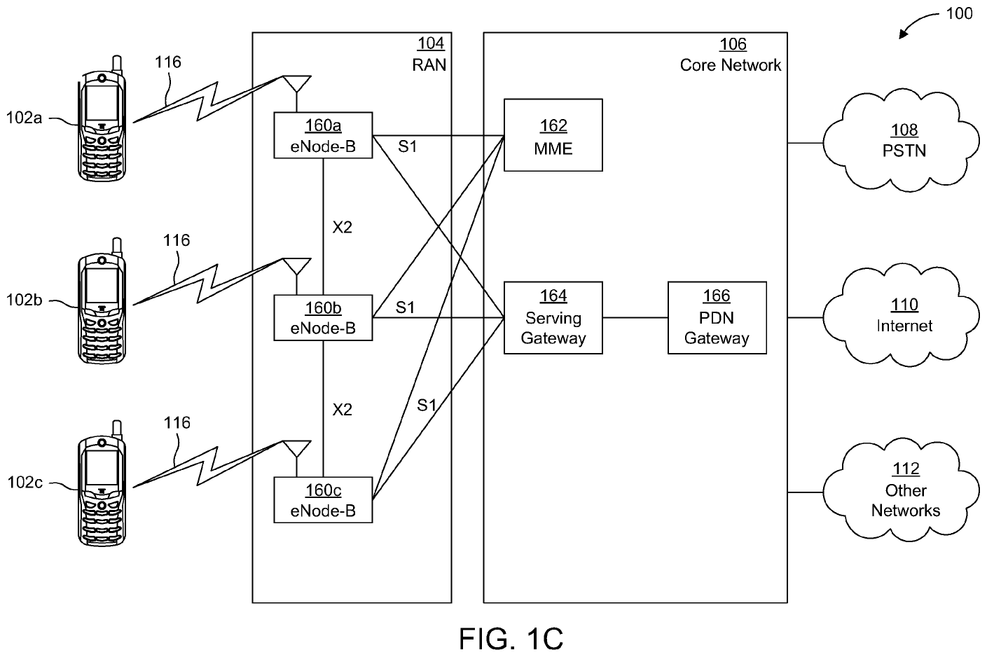

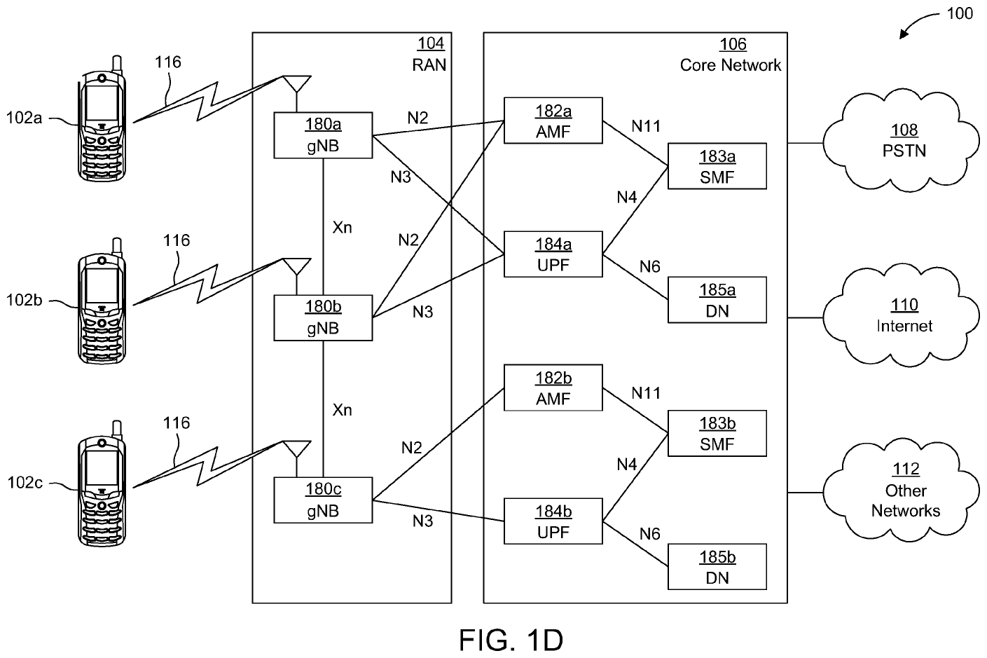

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In state-of-the-art wireless technology such as cellular and WLAN, RF front ends may be a mix of passive and active components. For example, passive components may include Rx antennas, Tx/Rx path switches and filters. These components require little if any power to function. Conversely, active components require power to function. For example, the oscillator to tune to the carrier frequency, the low noise amplifier and the A/D converters in the Rx path are active components.

Advances in RF component design over the last years have made it possible to use a novel type of RF circuitry that can process received RF waveforms which are collected through the antenna front-end by the receiving device in absence of an active power supply. For example, such a device may harvest energy from the received RF waveform to run the necessary circuitry to process signals. These passive receivers use RF components such as cascading capacitors, zero-bias Schottky diodes or MEMS to implement the functionality required for voltage multipliers or rectifiers, charge pumps and signal detectors. It is worth considering that passive receivers can operate in the antenna far-field and may support reasonable link budgets. In the following, the terms passive receiver and zero-energy receiver may be used interchangeably.

The passive receivers may perform basic signal detection such as correlation for a known signature waveform and/or they may be put into energy harvesting mode by accumulating energy from the RF waveform entering the receiver front-end through the Rx antenna. Link budgets characteristic of small or medium area cellular base stations are supported. For example, passive receivers may be used as wake-up radios to trigger device internal wake-up and signal interrupts following the detection of wake-up signaling which then prompts the main modem receiver using active RF components to start up.

The reduction in device power consumption may be considerable when passive receivers are used. A typical cellular 3G, 4G, or 5G modem transceiver may easily require up to a few hundred milli watts (mW) to demodulate and process received signals during active reception such as in RRC_CONNECTED mode. Power consumption scales with the number of RF front-end chains active on the device, the channel bandwidth used for reception and the received data rate. When the device is in RRC_IDLE mode with no data being received or transmitted, cellular radio power saving protocols such as (e)DRX ensure that the receiver only needs to be powered on a few times per second at most. Typically, the device may then perform tasks such as measuring the received signal strength of the serving and/or neighbor cells for the purpose of cell (re-)selection procedures and reception of paging channels. In addition, the device performs AFC and channel estimation in support of coherent demodulation. Device power consumption when in RRC_IDLE is in the order of several mWs. In R15 eMTC and NB-IoT, sequence detection circuitry for processing of in-band wake-up signals in RRC_IDLE mode may also be implemented in the form of a dedicated wake-up receiver. This allows to power down the A/D converters and significant parts of the digital baseband processor. However, several active components in the RF front-end such as low-noise amplifiers and oscillators are still used. Device power consumption in RRC_IDLE may be reduced to about 1 mW.

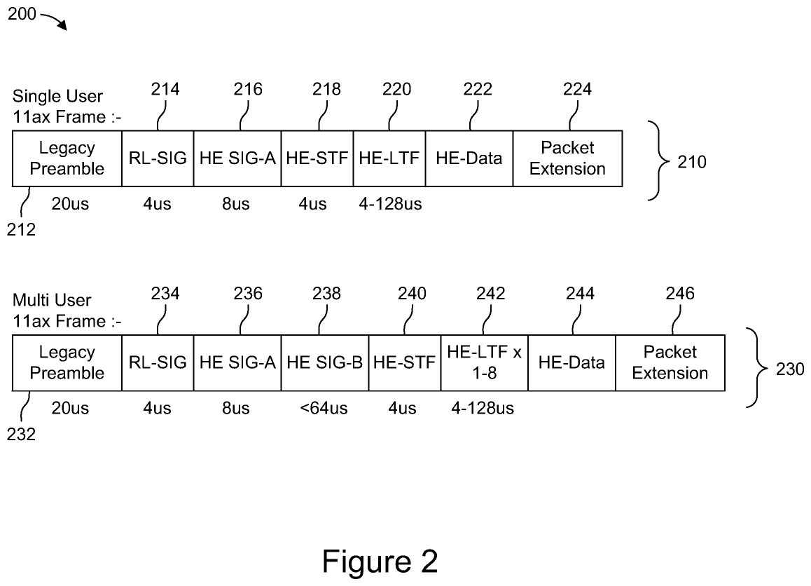

FIG. 2 illustrates an exemplary 802.11ax frame structure 200. FIG. 2 depicts both single-user frame structure 210 and multi-user frame structure 230. As shown, the structure may be similar to 802.11n and 802.11ac. It consists of preamble, header, and data fields.

The frame format starts with the preamble. The first part of the preamble consists of legacy (non-HE) training field 212 (single-user) or legacy (non-HE) training field 232 (multi-user). The second part consists of HE preamble fields. The legacy portion of the preamble contains L-STF (legacy non-HT short training field), L-LTF (legacy long training field) and L-SIG (legacy signal field). This legacy part may be decoded by legacy devices. It may be included for backward compatibility and coexistence with the legacy WiFi devices. RL-SIG field may be used as repeated legacy (non-HT) Signal field. The HE preamble may be decoded by 802.11ax devices only. HE preamble may include HE-STF and HE-LTF patterns. The HE header may include of HE SIG-A and HE SIG-B fields. HE SIG-A may include information about packet to follow both in downlink and uplink, MCS rate, modulation, BSS color, BW, spatial stream, remaining time in transmit opportunity etc. HE SIG-B may include only multi-user packets. HE-Data field carries PSDU(s). Max. packet extension modes of duration either 8 μs or 16 μs are used at the end of the 802.11ax frame.

The single-user frame format structure may also include of a RL-SIG field 214, HE SIG-A filed 216, HE-STF field 220, HE-Data field 222, and Packet Extension field 224. The multi-user frame structure may also include a RL-SIG field 234, HE SIG-A field 236, HE SIG-B field 238, HE-STF field 240, HE-LTF field 242, HE Data field 244, and Packed Extension field 246.

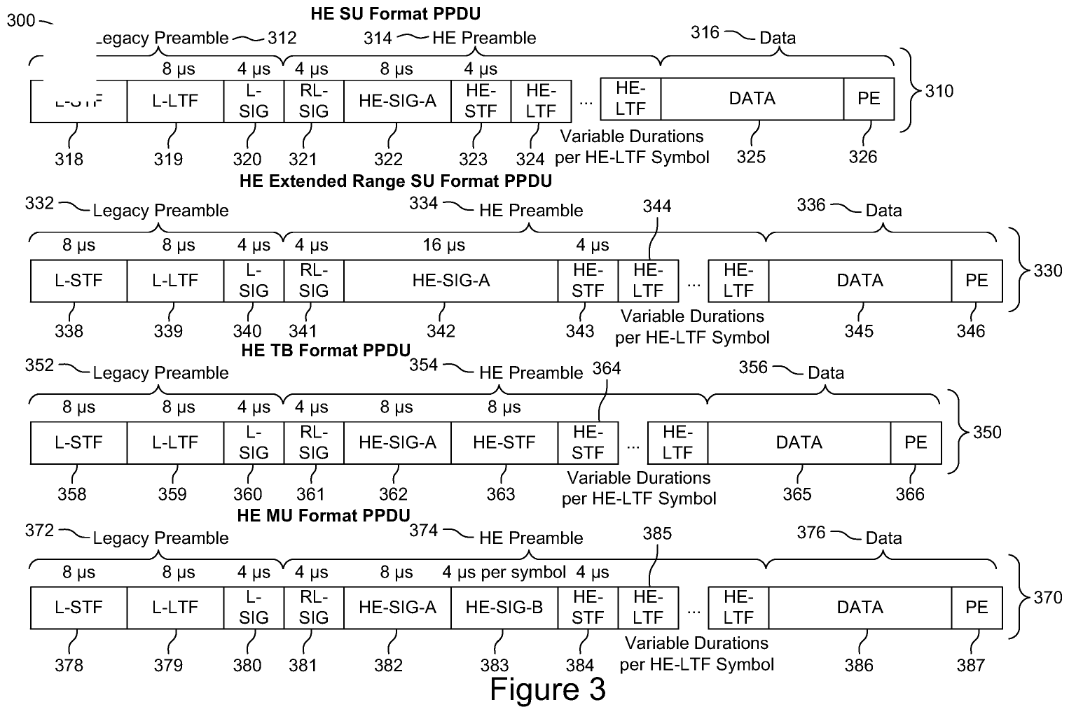

FIG. 3 illustrates an exemplary 802.11 PPDU format 300. 802.11ax may be also termed High Efficiency (HE) in short in the 802.11 specifications. In HE, there are four transmission modes supported: single user (SU), single user extended range (extended range SU), trigger-based, and multi-user (MU).

The HE SU PPDU format 310 may be used when transmitting to a single user. HE SU PPSU format 310 may include a Legacy Preamble 312, HE Preamble 314, and Data fields 316.

The Legacy Preamble 312 may include a L-STF field 318, L-LTF field 319, and L-SIG field 320. L-STF field 318 may be 8 μs. The L-LTF field 319 may be 8 μs. The L-SIG field 320 may be 4 μs.

The HE Preamble 314 may include a RL-SIG field 321, HE-SIG-A field 322, HE-STF field 323, and HE-LTF field(s) 324. The RL-SIG field 321 may be 4 μs. The HE-SIG-A field 322 may be 8 μs. The HE-STF field 323 may be 4 μs. The Data fields 316 may include a Data field 325 and PE field 326.

The HE extended range SU PPDU format 330 may be used when transmitting to a single user, but further away from the Access Point (AP) such as in an outdoor scenario. HE extended range SU PPSU format 330 may include a Legacy Preamble 332, HE Preamble 334, and Data fields 336.

The Legacy Preamble 332 may include a L-STF field 338, L-LTF field 339, and L-SIG field 340. L-STF field 338 may be 8 μs. The L-LTF field 339 may be 8 μs. The L-SIG field 340 may be 4 μs.

The HE Preamble 334 may include a RL-SIG field 341, HE-SIG-A field 342, HE-STF field 343, and HE-LTF field(s) 344. The RL-SIG field 341 may be 4 μs. The HE-SIG-A field 342 may be 16 μs. The HE-STF field 343 may be 4 μs. The Data fields 316 may include a Data field 345 and PE field 346.

A HE trigger-based PPDU format 350 may be used for uplink OFDMA and/or MU-MIMO transmission. It carries a single transmission and may be sent as an immediate response to a Trigger frame sent by the AP. HE trigger-based PPDU format 350 may include a legacy preamble 352, HE preamble 354, and data fields 356.

The Legacy Preamble 352 may include a L-STF field 358, L-LTF field 359, and L-SIG field 360. L-STF field 358 may be 8 μs. The L-LTF field 359 may be 8 μs. The L-SIG field 360 may be 4 μs.

The HE Preamble 354 may include a RL-SIG field 361, HE-SIG-A field 362, HE-STF field 363, and HE-LTF field(s) 364. The RL-SIG field 361 may be 4 μs. The HE-SIG-A field 362 may be 8 μs. The HE-STF field 363 may be 8 μs. The Data fields 316 may include a Data field 365 and PE field 366.

A HE MU PPDU 370 format may be used when transmitting to one or more users. It may be similar to SU format, except that an HE-SIG-B field may be present. A HE MU PPDU 370 format may a Legacy preamble 372, HE Preamble 374, and Data fields 376.

The Legacy Preamble 372 may include a L-STF field 378, L-LTF field 379, and L-SIG field 380. L-STF field 378 may be 8 μs. The L-LTF field 379 may be 8 μs. The L-SIG field 380 may be 4 μs.

The HE Preamble 374 may include a RL-SIG field 381, HE-SIG-A field 382, HE-SIG-B field 383, HE-STF field 384, and HE-LTF field(s) 385. The RL-SIG field 381 may be 4 μs. The HE-SIG-A field 382 may be 8 μs. The HE-SIG-B field 383 may be 8 μs. The HE-STF field 384 may be 4 μs. The Data fields 316 may include a Data field 386 and PE field 387.

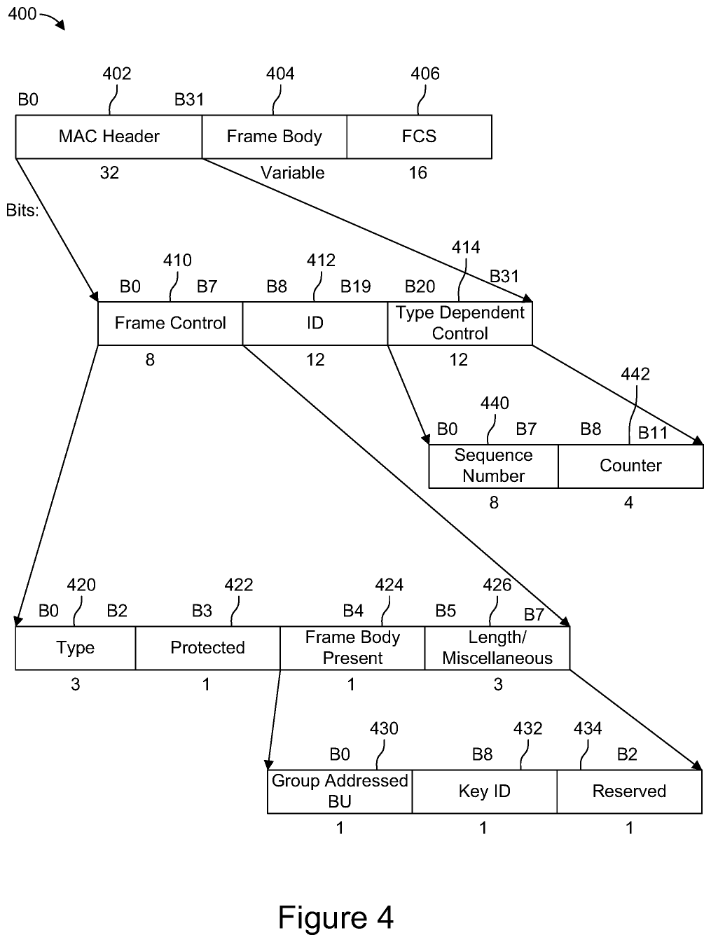

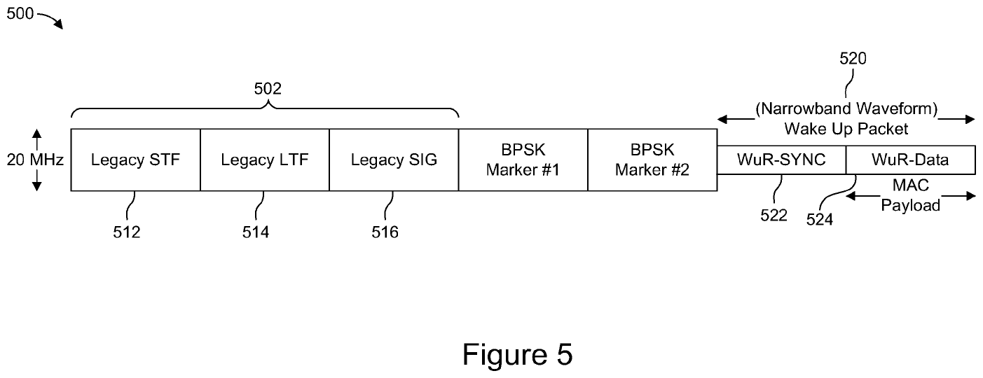

FIG. 4 illustrates an exemplary MAC frame 400 containing a wake-up packet. The MAC frame 400 may include a MAC Header 402, Frame Body 404, and FCS 406. The MAC Header 410 may include a Frame Control field 410, ID field 412, and Type Dependent field 414. The Frame Control field 410 may include a Type field 420, Protected field 422, Frame Body Present field 424, and Length/Miscellaneous field 426. The Length/Miscellaneous field 426 may include a Group Address BU field 430, Key ID field 432, and Reserved field 434. The Type Dependent field 414 may include a Sequence Number field 440 and Counter field 442. The MAC packet may be preceded by the 802.11 “legacy” PHY-PDU format and an 802.11ba PHY preamble that facilitates synchronization as shown in FIG. 5.

FIG. 5 illustrates an exemplary 802.11ba wake-up packet 500. The 802.11ba wake-up packet 500 may include a “legacy” portion 502, which may include a Legacy STF field 510, Legacy LTF field 512, and Legacy SIG field 514. The 802.11ba wake-up packet 500 may also include a BPSK Marker #1 504 and BPSK Marker #2 506. The narrowband portion 520 may include a WuR-Sync field 522 and WuR-Data field 524.

The “legacy” portion 502 of the packet may enable all legacy devices to decode the presence of the 802.11 conformant PHY PDU and subsequently ignore the contents for the entire duration as indicated within the duration element of the Legacy SIG field. This method enables coexistence of 802.11ba receivers with legacy 802.11 waveforms. The 802.11 stations (STA) incorporate a Wake-up Receiver (WuR) which look for a specifically encoded waveform (e.g., OOK) to determine the presence of a WuP. The WuR may be a dedicated, low-power receiver or may be an incorporated component with the Primary component Radio (PCR). The WuR listens to WuP and expends significantly lower energy than the PCR in receive mode. When a WuP is received and when WuR successfully detects the WuP, the WuR wakes-up the PCR.

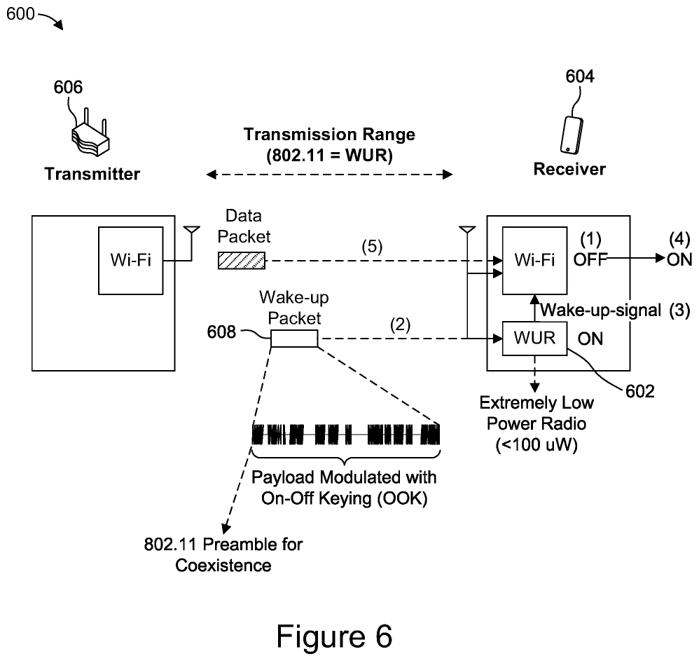

FIG. 6 illustrates an exemplary 802.11ba wake-up procedure 600 with a WuR 602. As shown in FIG. 6, PCR (“receiver”) 604 may negotiate with the AP (“transmitter”) 606 and enter PSM. The AP 606 requires transmission of a data packet on the downlink towards the PCR 604. The AP 606 may transmit a WuP 608 encoding the “identity” of the WuR 602 associated with the PCR 604. This identity may be indicated by the AP 606 to the PCR 604 during “Wake-up mode” negotiations during earlier stages before entering PSM. The WuR 602 may then decode the WuP 608 (potentially one of more WuP are necessary for a wake-up) and if the identity is correlated, sends a wake-up signal to the PCR 604. The PCR 604 may transition from an off state to on state, transmit a Poll PDU to the AP 606 enquiring pending data. The AP 606 may then transmit the buffered data to the PCR 604 using one or more exchanges. At the completion of the procedure, PCR 604 may re-enter an off state and WuR 602 may enter an on state.

In the example above, the AP 606 that supports this WuP 608 transmission may be called a WuR AP per IEEE 802.11ba specifications. As seen in FIG. 6, the WuR 602 does not know that a WuP 608 is addressed to itself until it decodes the MAC portion of the WuP 608. The expended power by the WuR 602 to decode the PHY PDU as well as the MAC PDU may be assumed to less than the power that may be expended if the PCR 604 were to be used. As the number of STAs associated with the WuR APs increases, the WuR-SYNC portion of the PHY PDU may be used for synchronization purposes and as a trigger for all the STAs equipped with WuR to become aware of the WuP 608. However, the identity of the WuR 602 may be encoded within the MAC PDU and this forces all the WuRs to decode the MAC PDU before deciding to discard. As the number of WuRs increases, the power consumption requirement to decode unnecessary WuPs exacerbates. This increase in WuP 608 decodes decreases the battery standby time especially when the primary reason for WuR 602 may be to prolong battery life. In summary, the state-of-the-art solutions involve waking up several WuRs when there may be a need to wake-up only one or a subset of WuRs and the WuRs must decode the MAC PDU to verify the addressing.

Within the 3GPP framework, unlike existing state-of-the-art devices, a wireless transmit/receive unit (WTRU) implementing a passive transceiver may benefit from near zero power consumption when it is not actively performing transmission or high data rate reception for the purpose of either exchanging data or large amount of control signaling with the network. A ZE receiver has already been considered to perform the following functions when in RRC_IDLE/INACTIVE state and while harvesting energy.

To enable a WTRU to further reap the benefits of the near zero power consumption associated with the ZE transceiver, the WTRU may utilize the ZE transceiver with backscattering-based UL to perform any of the random-access and/or data transmission procedures. A WTRU may then utilize a serving BS's interrogation signal to perform mono-static backscattering of MSG1 of a 4-step random access type or of MSGA of a 2-step random access type. The WTRU may also utilize the help of other WTRUs or facilitators to perform bi-static backscattering of either of the two messages MSG1 or MSGA.

Given the dependency of ZE transceiver transmissions on interrogation signal from either the serving cell (BS) and/or other WTRUs/facilitators, procedures that enable the coordination between the network and WTRUs equipped with ZE transceivers are required for energy and resource efficient random access and grant-free access operations. Frame structures that enable the efficient signaling in support of RRC_IDLE/INACTIVE states functionalities over a ZE air-interface without significant power consumption overhead to ZE receivers are required.

802.11 systems are ubiquitous and most practical scenarios, there exists 802.11 traffic between two peer entities despite the presence of other radio access technologies. For example, in airports or in office environment, it is common to find communication services utilizing terrestrial cellular systems as well as 802.11 networks. 802.11 is also the more ubiquitous, at least currently, in that a dominant fraction of the data traffic is typically carried over 802.11 than on terrestrial cellular systems. This could be due to the existing status that traffic is usually not metered over 802.11 whereas it is metered and tariffed over cellular systems, typically. Thus, it is useful to make use of 802.11 to not just be a source for information delivery but also for power delivery in the form of optimized waveforms for energy harvesting electronic circuitries.

A Zero Energy (ZE) device is an ultra-low powered communications device that may either be a supplementary device attached to a main radio (or) a stand-alone device such as an IoT device. The supplementary device in one representation may be a Wake-Up receiver (WuR). The ZE device may be built to contain very few or nil active components thus minimizing energy drain for either uplink (or) downlink transmissions. This nearly battery-free operation depends on the ZE device harvesting energy from ambient or dedicated sources (or a combination of both) to participate in information reception and energy harvesting. The ZE device may also use backscattering techniques using similar ambient or dedicated sources to modulate-backscatter information to intended recipients.

A wake-up receiver (WuR) may be a supplementary or standalone communication device. In 802.11ba, the WuR may be a supplement to a main transceiver component within the 802.11 framework. One of the WuR's primary purposes may be to allow the main transceiver component to turn off most of its active circuitry and enter power save mode. The WuR stands guard while the main transceiver is asleep. The WuR may receive “paging signals or wake-up signals” from the serving AP and wake-up the main transceiver component upon successful reception.

In the proposed embodiments, the WuR may be may take pre-programmed and/or pre-determined decisions on behalf of the main transceiver inclusive of participating in low-rate communications. The WuR may utilize energy harvesting (EH) and backscattering capabilities to undertake the communications. The EH and regenerating capabilities may have an implication on the energy storage requirement. In the proposed embodiments, the WuR may be more complementary than supplementary because it may perform certain standalone functions.

The Primary Communications Receiver (PCR) may be the main transceiver component. In one implementation, the PCR may be a standard 802.11 STA. The STA may have a finite but declining energy store (in the example case of a STA embodied in a handset) or the STA may have a finite but static energy store (in the example case of a STA embodied in a desktop PC). In the case of a handset, the PCR may benefit from a WuR because the STA may shut off most of its active circuitry and depend on its WuR to be woken up upon AP's paging. The PCR may typically participate in high-rate communications reaching several Mbps (or even Gbps) of data rates.

A wake-up packet (WuP) may be a paging signal transmitted by an AP or infrastructure node intending to wake up one or more WuR(s). In some representations, the WuP may be more than just a wake-up signal and may facilitate supporting functions such as phase/frequency tracking, local oscillation drift correction, alerting of specific procedures etc. The WuP may be a purely physical layer signal (i.e., consumed and terminated in what is normally a PHY procedure), a MAC layer signal (i.e., a signal that is embedded inside a framed format) or a signal consumed by an application (for example, public safety messages triggering certain alert framework to be instantiated).

Though there are advantages to each signal type, for WuRs, a signal type that may be least burdening on the energy store is appropriate. If a WuR receives a WuP and determines that it is not the intended addressee, there is significant energy wasted because a WuR's energy store is significantly smaller. In the proposed solution, the WuR may terminate earlier when it detects based on hierarchical rules that the WuP is not addressed to it. Further, the WuP may be consumed (or) discarded at PHY processing.

In most scenarios, a signal has a singular goal. For example, between two correspondents, a flag raised could signal danger and the flag hidden could signal normalcy. However, design variants may modify these design variants. For example, a third state may be added which could be a raised flag but tilted to the right by forty-five (45) degrees signaling the direction of the danger source in additional signaling danger.

In a proposed embodiment, various WuPs may be mapped to specific functions (or procedures) and agreed upon by two peer communicating entities. The same WuPs or nested WuPs intended for one function at WuR #1 may also be used and/or assigned to other WuRs. The peer node in charge of performing the wake-up may hierarchically determine WuPs that may wake-up one-singular, one-group or multi-groups of WuRs. The WuP may also be synonymously termed “signature or preamble.” The WuP may be a sequence, such as a M-Sequence or any appropriate code-sequences that may make WuRs orthogonal while ensuring high decodability performance in the PHY layer.

A preamble clip may be a portion of a WuP. It may be a fractional part of a WuP and may be formulated as follows: if a preamble is a length N sequence, the preamble clip may be a fractional part occupying K consecutive bits of the length N sequence with K<=N. While N may be typically fixed for a specific radio access technology, K may be deployment specific. (N−K) bits of the WuP are used for a different procedure. The preamble clip has special significance since the WuR correlating the N bit WuP may terminate early once K bits are deemed invalid for its purpose. Thus, one may visualize the preamble clip as implicit indicators of transmitting entity's identity and/or transmitting entity's remit and/or receiving entity's subscription to a network.

In wireless communications systems, synchronization between transmitter and receiver is usually necessary. In 3GPP based terrestrial cellular systems, the synchronization may be achieved when the WTRU successfully receives the primary and secondary synch signals (PSS/SSS) and disciplines its local oscillator. The WTRU may be always in downlink synch with the base station in such technology. In 802.11, the synchronization may be achieved when the stations read the 802.11 headers that contain the synchronization and training fields.

In 802.11ba, a scanning mechanism called discovery may be incorporated to enable STAs to detect mobility. WUR discovery frames are used to allow the STA for low power network discovery without interruption of the connectivity with the current AP and discovery through selected channel scanning. The STA may be associated with the strongest signal. 802.11ba compliant AP configures the STA with “fast initial link setup” discovery frames allowing it to switch channels and scan for APs on indicated channels. If a stronger AP is deemed to be present on the channels indicated in discovery frames, the STA may reassociate.

The proposed embodiments avoid the need for a separate channel and a need for the STAs to reassociate if not necessary. For example, if the STA is an Internet-of-Things (IoT) sensor (e.g., ocean level monitoring sensor near an oil rig) device that transmits a packet once every 24 hours, it need not reassociate to a different AP if it finds itself having drifted to that AP from its previous AP's location since the sensor's next transmission opportunity may be a further 21 hours yet. Unless there is a necessity, there is no necessity to associate since the same IoT sensor may drift further to another AP in the same BSS or with probability drift back to the same initial AP to which it is associated. The solution allows the device to determine that it has moved from one AP to another AP, determine if the new AP is part of the same BSS (or) a logical grouping that is known to be acceptable, receive wake-up signals from one or more APs that share a groping (say, a BSS) and reassociate to a new AP only if necessary.

In the current art, the WuP may be a singular type and singular purpose. More importantly, the current art allows the WuR to determine the wake-up signal after decoding the signal's MAC frame. The effect of a WuP may be translated to either (1) wake-up the PCR or (2) no action.

In a proposed embodiment, the peer transmitting entity may enable the ZE WuR to take one or several actions: (1) Defer the wake-up until an event or an opportunity conveniently exists, (2) Wake-up in full to participate in duplex, two-way, communication, and/or (3) Wake-up partially to consume a downlink only payload with no feedback etc.

A header-less control element may be an argument to a WuP that is fixed in size and may nominally consumed within the Physical layer. The physical layer consumes the WuP (correlates for example, the WuP signature) and decodes the augmented fixed-sized payload of few bits in the hardware without a need for an additional microprocessor.

A preamble tracking set may be a set between 1 and M WuPs that are associated with the WuR. The WuR may be assigned usually explicit procedures a set of M WuPs to track and decode or the WuR implicitly derives up to M WuPs applicable for its being serviced within the AP (or) BSS. The set M may be dependent on deployment and the type of services expected under an infrastructure. The tracking set indicates the comprehensive addressing of a WuR (or one or more WuRs in the case of group wake-up) within a BSS. Conversely, a WuP not in the tracking set may be an indicator of the WuR being under a non-serving AP (or) BSS.

A peer node depending on relative priority of a ZE WuR amongst several WuRs may assign hierarchically encoded WuPs. A WuP of length N bits may encode hierarchy such that the highest priority WuRs may terminate a decode as soon as they detect the first few bits mismatching whereas the lower priority WuRs may have to correlate fully before determining the need to terminate decode. For example, in a group of ZE-WuRs (1, 3, 5), suppose ZE-WuR 1 is higher priority than both ZE-WuRs 3 and 5 while ZE-WuR 3 is higher priority than 5. The WuP signature encodes a hierarchy which allows ZE-WuR 1 to skip the decode much earlier than ZE-WuR 3 and 5 if the WuP is not addressed to it. In a WuP signature of N bits, suppose the last J bits are used to indicate hierarchy. (N−J) bits are decoded by all ZE-WuRs 1, 3, 5. However, ZE-WuR 1 needs to decode j<=J bits to detect that the WuP is not addressed to it whereas ZE-WuR 3 needs to decode (j+d)<=J bits to detect that the WuP is not addressed to it and finally ZE-WuR 5 needs to decode up to (J+d+e)<J bits to determine that the WuP is not addressed to it.

STAs that are configured with Discovery channels detect the presence of other APs by tuning to channels signaled within the Discovery channel. When associating with the new AP discovered through this process, the selection may be based on received signal strength (the strongest, the 1st selected) with no real idea behind whether there may be sufficient capacity in the select AP for association. An optimization is proposed to the current art to signal quantized representations of relative capacity, likelihood of successful association etc. The STA may receive these inputs to determine which AP it prefers to associate with and not always the strongest that it measures.

Proposals for new frame formats within the 802.11 framework (as extensions to 802.11ba for example or a new interface) that allow coexistence of ZE WuRs with legacy, current art devices, in a new infrastructure supporting upgrades to the 802.11 specifications. The frame formats allow for correct interpretation by both legacy and ZE WuRs for information transmission and energy transfer. The energy transfer may be opportunistic or dedicated to the ZE WuRs and may be concurrent.

Concurrent delivery of power and information may be a process through which both information and energy are delivered to intended recipients. Frames that are information bearing to one STA may incidentally piggyback power optimized energy waveforms for WuR STAs. The signatures are chosen in such a manner that the harvesting targets may be met progressively and within confined durations. In a converse, an in-band full duplex infrastructure node may transmit information to a regular node and a ZE WuR device may opportunistically backscatter on the time-frequency resources as if it were an interrogation signal.

Transient storage may be not specific in that it may include certain low capacitance, quick-chargeable, temporary small battery, or other form of energy storage. In a receiver's high-level design for optimal operation, two crucial variables during the receive operation are considered: incident signal strength (power level), and current energy store level. Device operation may be characterized in terms of conceptual fundamental thresholds that govern its receiver operation. Depending on the stage of receive processing while receiving a ZE frame and based on the PHY frame structure, an active ZE WuR receiver may be in one of two basic states: Signature Detection, i.e., Searching/Listening for a ZE WuP or Data Frame Decoding/Reception. In this approximation, the fields that need to be understood are Minimum Energy required to operate and/or detect, a signal power threshold to commence harvesting and a threshold to declare sufficiency.

Described Below, are at least two proposed solutions. One proposes enhancements to the frame format in 802.11 and another where the STAs employ a zero-energy wake-up receiver (ZE-WuR) component that minimally expends energy for performing wake-up functions.

In one proposed solution of ZE-WuR, the ZE-WuR need not decode the entire WuP and may terminate early. The initial portions of the WuP provide sufficient information to the ZE-WuR to determine whether the WuP is addressed to itself and also use the same WuP for performing synchronization procedures. The MAC PDU information in the WuP is decoded only if necessary.

The WuP may be constructed as a WuP preamble immediately followed by a WuP MAC payload. The WuP may be transmitted by the ZE-WuR AP that intends to wake up the PCR of one or more STAs. The PCR of the STA may be woken up by the associated ZE-WuR. In this proposed solution, the wake up may be performed with a physical layer preamble. The preamble may be a M-sequence of length N bits. The length of the preamble N may be variable and may be dynamically determined by the ZE-WuR AP.

The preamble may solely be used by the receiving ZE-WuRs for one of at least three main reasons: (1) synchronization; (2) determining if ZE-WuR AP has addressed a wake-up command; and (3) the purpose of wake-up. The proposal involves assigning unique (or) carefully managed preamble sequences to ZE-WuRs. During the time of association, the PCR of the STA exchanges “wake-up” mode setup parameters and receives one or more WuP preamble identities.

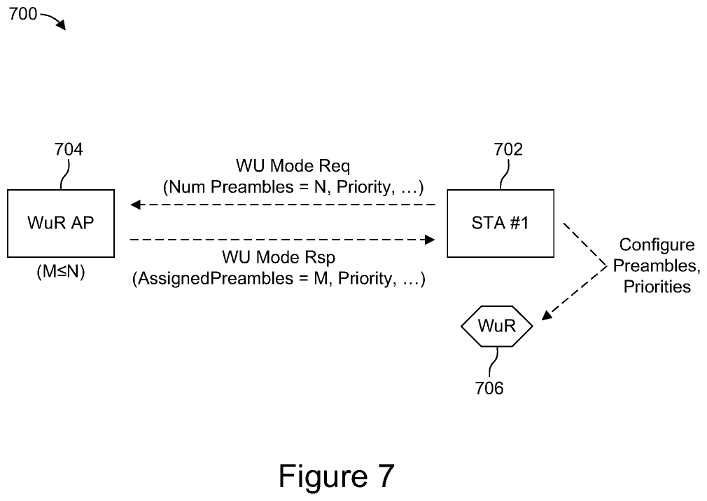

FIG. 7 illustrates an exemplary wake-up preamble configuration 700. As seen in FIG. 7, the PCR of the STA 702 engages in Wake-up Mode exchanges with the ZE-WuR AP 704 indicating the number of preambles and internal priority handling of different WuP. The STA 702 may indicate that it is able to accept up to N different ZE-WuR Preamble sequences. The ZE-WuR AP 704 configures up to M preambles, M<=N, the preamble information to the STA 702 indicating the mapping between “Preamble function” and “Priority assigned” locally. For example, “Preamble function #1” may be “Wake up, Power-on humidity sensor” whereas “Preamble function #2” may be “Wake up, Transmit standby power status”. In one embodiment, preamble “functions” are enforced by the ZE-WuR AP 704 itself and in a related embodiment, the ZE-WuR 706 wakes up the PCR to carry out the preamble “functions”. The preambles are function specific that either the ZE-WuR 706 or the PCR would need to carry out after waking up.

In one embodiment, the ZE-WuR AP 704 may determine the number of preambles it is able to assign to the STA and responds with up to M “function-specific” preamble sequence indices to the STA, M<=N. The priority assigned to each preamble may be also indicated by the ZE-WuR AP 704 to the ZE-WuR STA. The PCR of the STA configures the preambles and the priorities at the ZE-WuR AP 704. Once the zero-energy mode is entered, the ZE-WuR AP 704 listens to preambles and determines whether the preamble is addressed to it and whether the PCR needs to be woken up or whether it may carry out the tasks itself.

In 802.11ba, several M-sequences are analyzed for synchronization performance and those M-sequences that meet the “balance” and “run” criteria were deemed to exhibit almost identical performance when employed as WuR SYNC packet for Low-Date rate and High-Data rate. The selected M-sequence that is standardized is in Equation (30-9) of 802.11ba/D6.0. The utility of the M-sequence as a preamble for WuR SYNC has been amply studied in 802.11ba and corroborated in 17/0997r0 and 17/1343r0. However, the WuR SYNC may be used only for synchronization and trigger purposes but not for waking up the WuR uniquely.

Given a length K-bits, the number of different bit-sequences that may be formed is equal to 2K. If constraints are presented on what subset of 2K may be chosen, the usable choices will become restricted. For example, if the usable sequences must meet the “balance criteria”, then the number of usable sequences may be reduced to approximately 2K−1. In addition to that, if a further constraint of “run criteria”, the usable sequences are even further reduced. The “balance criteria” requires chosen sequences to have even number of zeros and ones in the sequence. The “run criteria” requires that chosen sequences cannot contain consecutive-1s or consecutive-0s exceeding a value run count ‘C’. For example, if the run criteria require sequences with number of consecutive-1s or consecutive-0s to be less than 5, then all sequences that have a run of 1s or 0s exceeding run-length 5 are unusable.

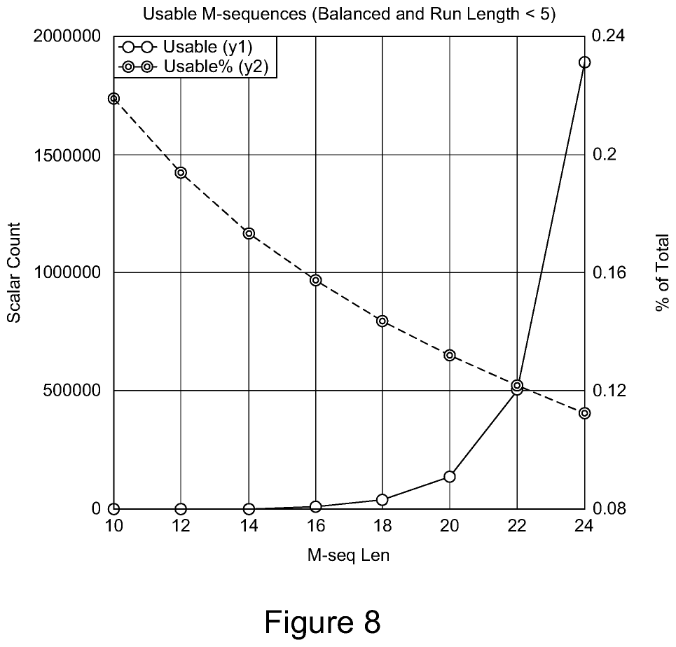

FIG. 8 illustrates the theoretical availability space for suitable preambles. As shown in FIG. 8, as the length of M-sequence increases, the number of usable sequences increase. The usable sequences as a percentage of the available sequences at each length decreases. However, the quantity of usable preambles may be significantly large. Using an arbitrary example, if the length of M-sequence is 24, usable sequences are approximately 1.8 million.

As per current 802.11 standards, the theoretical maximum associations at a ZE-WuR AP may be around 2000. If the maximum number of associations that may be supported is known, it enables determination of mean assignable preambles per associated STA. Note however that some preambles may be mapped to a group of STAs and the ZE-WuR AP may decide to wake several PCRs at the same time. The determining factors as to how STAs are grouped to a particular preamble may be several. For example, a group of STAs may be mapped to a particular wake up preamble given (1) their proximity to each other, i.e., geographical proximity, (2) capability of the STAs (e.g., sensors of a particular type), and/or (3) distance from the WuR AP (e.g., via long term pathloss estimations to/from the STAs).

In 802.11ba, the M-sequence do not encode any identity of any WuR STA. It is purely aimed as a mechanism for WuRs to maintain synchronization. There is also a cyclic shift applied to the 13 subcarriers on which the WuR SYNC is transmitted. A single M-Sequence of length 32 may be used as WuR-SYNC in 802.11ba for LDR. A bit-wise complement of the same sequence is used for HDR. The WuRs receive the WuR SYNC and correlate by comparing it with the expected sequence. If the received sequence is correlated, the WuR wakes up the PCR in order to perform MAC-PDU decoding. In one embodiment, the WuP Preamble may be a N bit preamble which may be split into ‘A+B’ bits. ‘A’ bits of the ZE-WuR preamble may be termed the “Preamble clip” and indicate the identity of the ZE-WuR AP. ‘B’ bits of the WuP Preamble may be the “ZE-WuR Identity” that identifies individually or a group of ZE-WuRs.

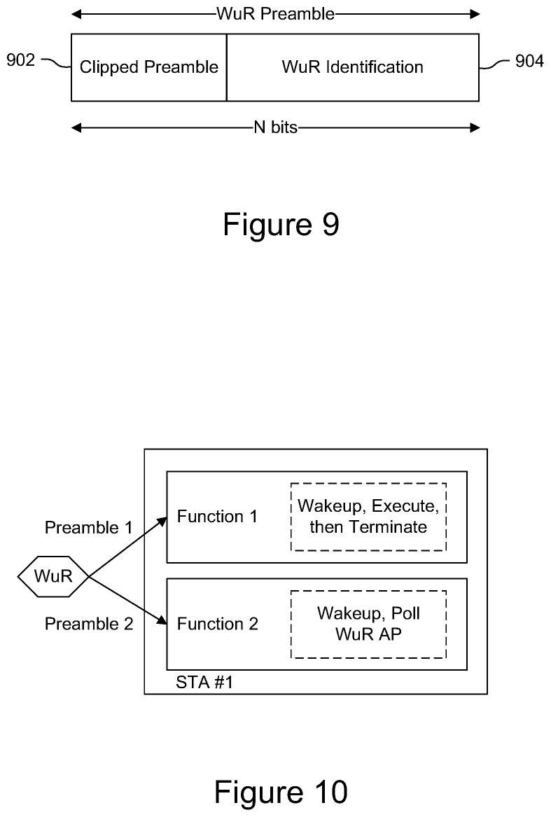

FIG. 9 illustrates an exemplary construction of the WuP described above. As seen in FIG. 9, the length of the preamble clip 902 may be sufficiently long enough for WuRs to perform synchronization. In one embodiment, the length of the preamble clip may be dynamically chosen by the ZE-WuR AP and the length may be either indicated explicitly to the STA or the STA programmatically derives the length. Since the identity of the ZE-WuR AP may be implicit in the preamble clip, any ZE-WuR that is associated with the ZE-WuR AP may use the preamble clip from any WuP Preamble to perform synchronization even if the WuP is not meant for itself. The identity portion of the WuP preamble enables the ZE-WuRs to determine whether the WuP is addressed to it. The set of preambles that a ZE-WuR AP may use is determined by the preamble clip. The preamble clip may be keyed into first K bits of the WuP preamble. For example: bits [1:K] are from a generator sequence that are keyed into the BSSID (or any other ID) of the ZE-WuR AP. The first K bits may also be an implicit identity with no specific derivation of or mapping to an AP's identity. Bits [K+1:N] are the ZE-WuR-Identification 904 bits. The total of N bits yield the ZE-WuR's wake up signature. The K bits of any ZE-WuR signature may be used by any ZE-WuR associated with the ZE-WuR AP (i.e., the domain of ZE-WuR AP) for synchronization purposes.

In one embodiment the preamble clip 904 may encode the AP identity. In such cases, a generator sequence may be known a priori between the ZE-WuR STA and ZE-WuR AP. Thus, the set of sequences that apply to a BSS may also be known a priori. The ZE-WuR AP may exchange one or more generator seeds with a STA during ZE-WuR Mode setup procedures. Based on the generator seed, the STA may derive the preamble clip(s) that are applicable within the ZE-WuR AP as well as the BSS. In one embodiment, the preamble clip in the WuP signature may assist the ZE-WuR to detect that it has left the catchment area of the currently associated ZE-WuR AP and into the catchment area of another WuR AP within a BSS or ESS. The collection of WuP signatures that a ZE-WuR may correlate is termed signature monitor set.

A ZE-WuR STA that is wandering from a geographical area served by a ZE-WuR AP to another ZE-WuR AP within the BSS/ESS may detect a potential change in server. The discovery mechanism that typically requires the ZE-WuR to monitor Discovery channels are unnecessary since the preamble clip may be used by the ZE-WuR to detect the serving ZE-WuR AP. In one embodiment, the ZE-WuR may be configured with one or more WuP signatures, the WuP signature consisting of a WuP Preamble clip and a WuR Signature. The ZE-WuR correlates for pre-configured list of WuP Preamble clips and detects whether it is under its serving ZE-WuR AP or has wandered into the catchment area of another ZE-WuR AP within the ESS/BSS.

In a related embodiment, the ZE-WuR may correlate the WuP preamble clip and use it for synchronization. The WuP preamble clip may be used by any ZE-WuR associated with the serving WuR AP since the preamble clips are configured at the ZE-WuR. The preamble clips may be indicated by the ZE-WuR AP during the association setup or the preamble clip may be derived by the ZE-WuR based on a generator seed and the ZE-WuR AP's identity. In one embodiment, the choice of WuP signature used by the ZE-WuR AP also implicitly indicates to the ZE-WuR whether it optionally may choose not to wake up the PCR. In a related embodiment, the WuP signature choice used by the ZE-WuR AP also may indicate to the ZE-WuR whether a deferred wake-up is preferable. If the ZE-WuR correlates and detects such a preamble, an implicit timing may be inferred by the ZE-WuR as the deferral it must incur before waking up the PCR.

In other embodiments, the preamble clip or the entire WuP signature may map to a function one-to-one. The ZE-WuR AP may configure several WuP Signatures at the ZE-WuR and indicate that each WuP maps to one or more functions that the ZE-WuR associated with the PCR may carry out. When the ZE-WuR decodes the WuP signature, the corresponding function to execute may be implicitly (or) explicitly derived. The choice of WuP signature triggers the ZE-WuR to execute the corresponding function. In a related embodiment, the WuP signature informs the ZE-WuR that a wake-up may be required but no reception or transmission need to occur. An example of such function involves the ZE-WuR receiving a WuP signature, waking-up the PCR to perform a temperature reading, store in local memory and returning to sleep. Alternatively, instead of waking up the PCR, the ZE-WuR may perform such function itself. In either scenario, a medium access may be unnecessary either for transmission or for reception of information on the 802.11 channel. FIG. 10 illustrates exemplary function specific WuP signatures.

In one embodiment, the ZE-WuR may correlate the entire WuP and matches the indicated ZE-WuR identity with the WuP signatures configured a priori. The ZE-WuR correlates and matches the WuP signature with the one or more identities that have been configured. The signature may be an individually addressed signature (wake-up for only one ZE-WuR) or alternatively, the signature may be a group addressed signature (wake-up for two or more ZE-WuRs). If the ZE-WuR cannot match preconfigured signatures with the WuP signature, it may forego decoding the MAC-PDU that may follow the WuP signature.

In one embodiment, a bank of K correlators may be used at the WuR to correlate a received WuP signature with the K signatures configured a priori. In an alternative embodiment, the WuR may be designed to implement reconfigurable correlators. The correlator at the WuR may be implemented as a programmable, low-powered device and modified, as necessary. In one embodiment, the WuP signature may encode hierarchical addresses. In a hierarchical scenario, the hierarchical identity has a cascading level of wake-up signatures. The ZE-WuR correlates for stored signatures by hierarchically decoding the received signature. When a hierarchy is broken, the ZE-WuR deems the signature invalid and terminates the decoding. The support for and the presence of hierarchal WuP signatures may be indicated by the ZE-WuR AP during the time of association.

In one embodiment, the size of the WuP preamble may be static and set to N bits. This size N, in such embodiment, may be common across all ZE-WuR APs regardless of geography. In alternative embodiments, the size of the WuP signature may be dynamic and may change from N bits to M bits. The size of the WuP signature that will be used by a ZE-WuR AP may be signaled to the STA during association setup. If the size may be dynamically changed without explicit signaling, the ZE-WuR AP indicates that dynamic WuP signature size is enabled in the system. In one embodiment, the choice of WuP preamble clip may be implicitly mapped to a dynamic length. The ZE-WuR in such embodiment correlates for the WuP preamble clip and depending on the preamble clip identifies the length of the WuP signature. In a further embodiment, the preamble clip may encode hierarchical length indication. The K bit preamble clip not only provides synchronization, it also enables the ZE-WuR to determine hierarchically the length of the WuP signature that the ZE-WuR must correlate.

It is also possible for the ZE-WuR to utilize both the preamble clip and the ZE-WuR identification portions for synchronization given the a priori knowledge of the tracked set of preamble clip and IDs. The tracked set of preamble clips may also be considered the monitored preamble set for the WuR.

In summary, the one proposed solution may be summarized as following: receiving WuPs partitioned as a preamble clip+WuR Identification signature; correlating the preamble-clip portion to determine transmitting entity; and correlating WuR Identification portion and performing function specific tasks.

The WuP signature may consists of twin partitioned preamble clip and WuR Identity. The Preamble clip may identify the transmitting AP as Serving AP and/or another AP within BSS/ESS. The AP identity may be encoded in the preamble clip. The ZE-WuR terminating may decode early if AP identity portion of the WuP mismatches. The Preamble clip encoding a dynamic length of K bits. ZE-WuR based on a seed generator sequence self-determining the complete set of Preamble clips applicable in BSS/ESS. ZE-WuR detecting an event of mobility based on preamble-clip of another AP within {BSS, ESS} without need for reassociation. ZE WuR requesting one or more function specific WuP signatures. ZE WuR indicating autonomously determined function priorities and support for programmable/reconfigurable preamble correlators. AP assigning one of more function specific signatures. ZE-WuR receiving function specific WuP and executing corresponding function without the need to wake up the PCR.

The WuP signature may be broadly classified into 5 types. WuP Type 1 may act as a SYNC for all ZE-WuR that is associated with a specific ZE-WuR AP. The ZE-WuRs associated with the ZE-WuR AP uses the WuP preamble clip for synchronization reasons from any WuP addressed to any ZE-WuR. A Type 1 may be used by the ZE-WuR for synchronization and clock correction purposes and the remaining portions of the WuP may be unnecessary to decode. This may be a WuP signature-based wake up and there may be no necessity to decode MAC PDU. Note that any ZE-WuR Type of packet acts as ZE-WuR Type 1 for any ZE-Wu R.

WuP Type 2 may be a “short-wake-up” indication addressed either to an individual or a group of ZE-WuRs. In the “short-wake-up” mode, the ZE-WuR wakes up the PCR only for the express purpose of “receiving” a short packet (or a finite known quantity of packets) from the ZE-WuR AP. The TXOP may be known a priori and the PCR stays up only to receive and upon completion of that routine, promptly re-enters sleep. This may be a WuP signature-based wake up and there may be no necessity to decode MAC PDU.

WuP Type 3 may be a “full-wake-up” indication addressed either to an individual or a group of ZE-WuRs. In the “full-wake-up” mode, the ZE-WuR may wake up the PCR fully. The PCR may be required in such full wake-up to poll the ZE-WuR AP and engage in conversational data transmission/reception. The full wake may be for the express purpose of “transmitting and/or receiving” several data packets to/from the ZE-WuR AP. The TXOP may not be known and the PCR may stay up as long as necessary to complete a routine after which it may resume sleep. This may be a WuP signature-based wake up and there may be no necessity to decode MAC PDU.

WuP Type 4 may be a “soft-wake-up” mode. The ZE-WuR may optionally wake-up the PCR. When a Type 4 WuP is received, the ZE-WuR AP may indicate that a “lower priority” procedure is pending for the STA at the ZE-WuR AP and that the PCR may be woken up on a best effort basis. A soft-wake-up also implicitly defines the maximum time that a ZE-WuR may choose not to wake up the PCR. An example of such a procedure may include a ZE-WuR mode renegotiation request which is not urgent. The ZE-WuR receives such as Type 4 WuP and sets a “delayed-wake-up” flag. When an opportunistic reason arises to wake-up the PCR or if the maximum time for delayed-wake-up expires at the ZE-WuR, the PCR gets work up. This may be a WuP signature-based wake up and there may be no necessity to decode MAC PDU.

WuP Type 5 may be a “need not wake up” mode. In the “need not-wake-up” mode, the ZE-WuR may receive a MAC-PDU that is meant for the PCR but no further transaction may be necessary. When a Type 5 WuP is received, the ZE-WuR may itself decodes the MAC-PDU and stores it into a local repository and sets a flag reminding PCR to act on the stored information later/time. An example of such a wake up would be a configuration upload/configuration modification for the PCR which may be a humidity sensor or an update to the calibration data.

With the exception of WuP Type 5, the ZE-WuR has no necessity to decode the MAC PDU. The wake-up determination may be made purely upon correlation of the WuP signature.

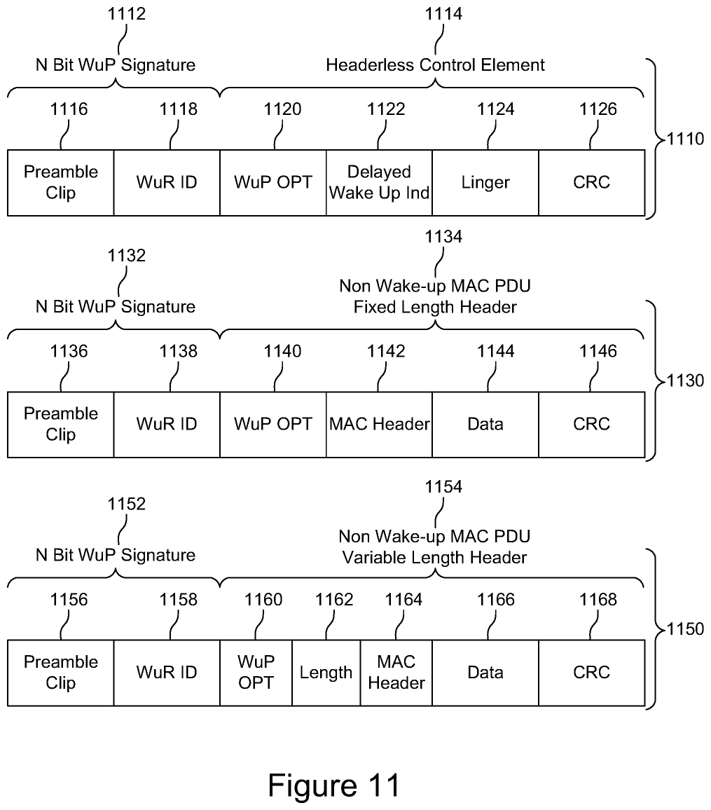

FIG. 11 illustrates five WuP types as described above. Types 1-4 are illustrated in the format 1110 of FIG. 11. Type 5 is illustrated in the format 1130 and format 1150.

The format 1110 may include a N-bit WuP Signature 1112 and Header less Control Element 1114. The N-bit WuP Signature may include a Preamble Clip field 1116 and WuR ID field 1118. The Header less Control Element 1114 may include a WuP OPT field 1120, Delayed Wake-up Indicator field 1122, Linger field 1124, and CRC field 1126. In the format 1110, there is no MAC header and following the WuP Signature 1112, there is only the Header less Control Element 1114. The Header less Control Element 1114 may be protected by the CRC field 1126. MAC processing refers to processing that may be traditionally performed at the MAC Layer inclusive of CRC computation. In the WuR Types above, the Header less Control Element 1122 may be considered an extension of the PPDU.

The ZE WuR continues to decode at least the WuR-OPT field 1120 of the WuP Packet and decode a few bits following that if WuP Type is 1-4. In this case, the PPDU may be as shown in the 1st part of the FIG. 11. In WuP Type 5, the WuR sees a much larger packet embedded within the MAC frame to decode the packet and this will be done potentially in a microprocessor. WuP OPT 1120 may be the field that indicates the ZE-WuR Type. The Delayed Wake-up Indicator field 1122 is present for ZE WuR Type 4. For a soft-wake up, the Delayed Wake-up Indicator field 1122 indicates the maximum time applicable for delaying the wakeup. The Delayed Wake-up Indicator field 1122 may be a timer or a quantized value representing a time offset from current UTC. The ZE-WuR receiving a ZE-WuR OPT indicating Type 4 wake-up wakes up the PCR at an opportunistic time. In the worst case, the ZE-WuR wakes up the PCR at the expiry of the wake-up delay time.

The Linger field 1124 is present for ZE-WuR Type 2 in case the ZE-WuR AP indicates the short wake-up should linger for a while due to uncertainties in channel access due to DCF. The ZE-WuR AP may transmit a short packet and has nothing additional to transmit. In other cases, the access to the media may involve a delay due to increased demand for the media from several contending transmitters. The ZE-WuR AP may indicate the ZE-WuR to inform the PCR to linger during the short wake up due to uncertainties in channel access. In all the types mentioned above, the information may be transmitted by the ZE-WuR AP as a PHY PDU with no MAC PDU component. To protect the veracity of the PHY PDU, a CRC may be attached to the header-less control element that follows the ZE-WuR Signature component.

Format 1130 and format 1150 illustrate a non-wake-up WuP Type, Type 5.

Format 1130 may include a N-bit WuP Signature 1132 and Non-Wake-up MAC PDU Fixed Length Header 1134. The N-bit WuP Signature 1132 may include a Preamble Clip field 1136 and WuR ID field 1138. The Non-Wake-up MAC PDU Fixed Length Header 1134 may include a WuP OPT field 1140, MAC header 1142, Data field 1144, and CRC field 1146.

Format 1150 may include a N-bit WuP Signature 1152 and Non-Wake-up MAC PDU Variable Length Header 1154. The N-bit WuP Signature 1132 may include a Preamble Clip field 1156 and WuR ID field 1158. The Non-Wake-up MAC PDU Fixed Length Header 1134 may include a WuP OPT field 1160, Length field 1162, MAC header 1164, Data field 1166, and CRC field 1168.

In Type 5, the wake-up reason may be not essential. For example, a sensor operator may wish to furnish a sensor equipment with a modified calibration file to correct for errors in previous sensing reports. The calibration file needs to be applied on the sensor before the next attempt to performing the sensing. The calibration data may be transmitted within a MAC PDU and the ZE-WuR may decode it and apply the calibration file into the PCR's file path where the information resides. In an alternative example, configurations meant for the sensor may need to be modified. The configuration file may be transmitted within the MAC PDU and the ZE-WuR may write the configuration file into a secondary bank after validating CRC. The PCR is not woken up at this time. When an opportunity requires the PCR to wake up, the presence of information/command sets in secondary banks force the PCR to act on the information.

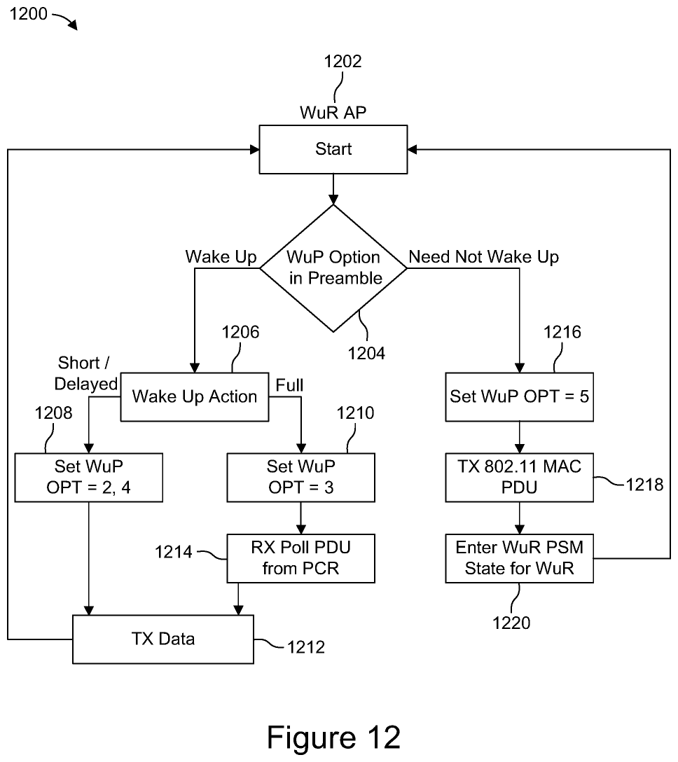

FIG. 12 illustrates the process 1200 of indicating wake up type. At 1204, the WuR AP determines the WuP wakeup option via the preamble. At 1206, ZE-WuR AP 1202 makes the determination as to what the ZE-WuR may be required to do following a wake up (i.e., wakeup action).

In one embodiment, at 1208, the ZE-WuR AP 1202 decides that the ZE-WuR needs to be woken up for a short duration of time. It sets the WuP OPT field to Type 2. After making a subsequent determination that the PCR has been woken up, at 1212, the ZE-WuR AP 1202 transmits the data payload to the ZE-WuR. In a follow-on embodiment, the ZE-WuR AP may transmit the WuP more than once depending on the confidence estimate on the probability of successful reception of the previous WuP.

In another embodiment, the ZE-WuR AP decides that the PCR needs to be woken up fully. At 1210 it sets the WuP OPT field to Type 3. At 1214, the ZE-WuR AP 1202 receives the poll PDU from the PCR. At 1212 the ZE-WuR AP 1202 transmits the data payload to the ZE-WuR.

In a follow-on embodiment, the ZE-WuR AP may transmit the WuP more than once depending on the confidence estimate on the probability of successful reception of the previous WuP. The ZE-WuR AP awaits an uplink transmission from the PCR before engaging in a data conversation.

In one embodiment, the ZE-WuR AP 1202 decides that the PCR needs to be woken up in a deferred but opportunistic manner. The ZE-WuR AP 1202 determines the maximum deferred time period before which the PCR must be woken up. The ZE-WuR AP sets the ZE-WuR OPT field to Type 4 and transmits the WuP. The ZE-WuR AP 1202 may transmit the WuP more than once depending on the confidence estimate on the probability of successful reception of the previous WuP.

In an additional embodiment, the ZE-WuR AP 1202 has data that is for PCR's consumption. The ZE-WuR AP sets the ZE-WuR OPT field to Type 5 at 1216 and creates the MAC PDU embedding the data field. The WuP inclusive of the MAC payload is transmitted to the ZE-WuR 1218. The ZE-WuR AP 1202 may transmit the WuP more than once depending on the confidence estimate on the probability of successful reception of the previous WuP. At 1220, the ZE-WuR AP 1202 enters a PSM state.

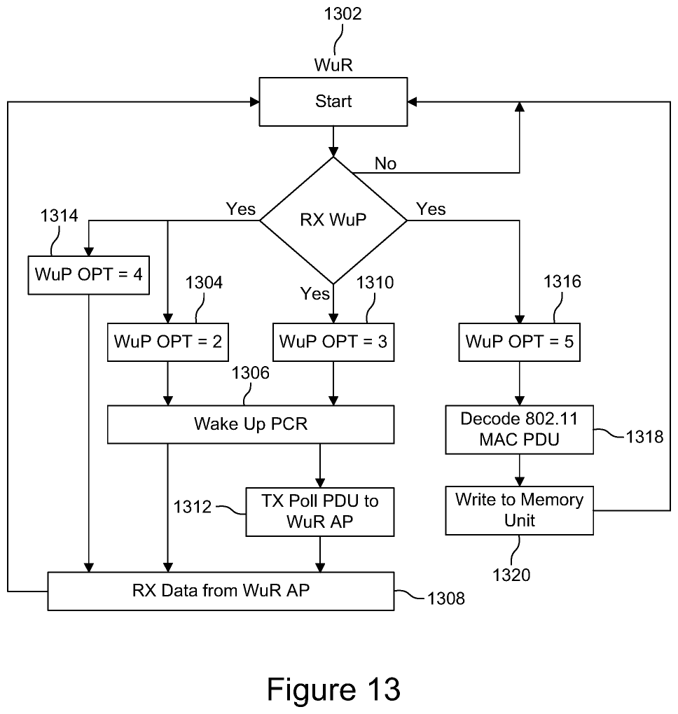

FIG. 13 illustrates the broad classification of WuP Types at the ZE-WuR 1302. In one embodiment, the ZE-WuR receives any WuP and considers it to be WuP Type 1. It may choose to perform synchronization procedures with the WuP.

In a second embodiment, at 1304, the ZE-WuR 1302 decides that the ZE-WuR AP had transmitted a ZE-WuR Type 2 WuP and that it needs to be woken up for a short duration of time. At 1306, the ZE-WuR 1302 wakes up the PCR indicating the WuP Type is Type 2. After the PCR has been woken up, at 1308, the PCR receives the short packet from ZE-WuR AP and indicates successful reception of the packet. It commands ZE-WuR to re-enter ZE-WuR mode and PCR returns sleep mode.

In a follow-on embodiment, the ZE-WuR 1302 decides that the PCR needs to be woken up fully. It does so by, at 1310, detecting the WuP OPT field as Type 3 that was transmitted in the WuP. At 1306, the ZE-WuR 1302 wakes the PCR up indicating the WuP Type as Type 3. As 1312, the PCR transmits a short poll PDU to the ZE-WuR AP indicating that it is ready to engage in a data conversation. At 1308, the PCR receives and transmits in a series of conversation with the ZE-WuR AP until it decides that the conversation may be ended. It commands its ZE-WuR to reinter ZE-WuR mode and PCR reinters sleep mode.

In one further embodiment, the ZE-WuR 1302 decides that its PCR needs to be woken up in a deferred but opportunistic manner. The ZE-WuR 1302 determines the maximum deferred time period before which the PCR must be woken up. The ZE-WuR 1302 infers this by, at 1314, detecting the ZE-WuR OPT field as set to Type 4 in the WuP. In a follow up embodiment, the ZE-WuR 1302 consumes the payload and determines the opportunistic occasions that it may choose to wake up the PCR. The ZE-WuR 1302 also determines the maximum deferred time before which its PCR must be woken up. When an opportunity arises to wake up the PCR, for example, a different WuP of a different Type was received later, or when the maximum deferred time expires, the ZE-WuR 1302 wakes up the PCR and indicates the wake-up type as Type 4. ZE-WuR 1302 passes on the payload that was received earlier with WuP Type 4. The PCR may use the Delayed Wake up Indicator field to determine the possible reasons why it was woken up.

In an additional embodiment, at 1316, the ZE-WuR 1302 determines that it has received a WuP with ZE-WuR OPT field set to Type 5. At 1318, the ZE-WuR 1302 decodes the entire MAC PDU that follows and validates the CRC. The ZE-WuR 1302 decodes the data payload embedded in the Data field within the MAC PDU and determines what it needs to perform with the information. In one example, at 1320, the ZE-WuR 1302 may write the MAC Data field contents into a configuration file in a secondary data bank or replace an existing configuration file in the primary data bank. The ZE-WuR 1302 does not wake up its PCR in this embodiment and returns to ZE-WuR 1302 mode after successful consumption of the MAC PDU.

During Wake-up mode setup procedure, the ZE-WuR AP may indicate to the STA that the ZE-WuR AP will either use dedicated or shared resources for transmitting its WuP. The STA configures its ZE-WuR with information regarding shared/dedicated resources for receiving the WuP. One or more ZE-WuR may be mapped to same resources. The location where the WuP will be transmitted for a given ZE-WuR may be a function of its Selector Identity. During the Wake-up mode setup procedure, the STA may be signaled a ZE-WuR Seed and a ZE-WuR Seed Window during which certain types of WuP may be sent to its ZE-WuR. Note however that a ZE-WuR Seed need not resolve into periodic sensing/reception time periods. WuP transmissions may be aperiodic. The ZE-WuR Seed Window may be long or short.

The ZE-WuR seed indicates the starting location in time where a ZE-WuR's WuP may be transmitted. The ZE-WuR seed window indicates the range in time within which the ZE-WuR may expect to receive its WuP. Both the ZE-WuR Seed and ZE-WuR Seed window are optional in that, WuP transmissions may be completely aperiodic without any granular time negotiation. WuP transmissions may be ad hoc and may be transmitted by the ZE-WuR AP on demand and for autonomous reasons.

The ZE-WuR Seed window length for a given ZE-WuR may be determined by the ZE-WuR AP based on request and recommendations by the STA during Wake-up Mode setup procedure. The length of the window may depend on ZE-WuR (or) PCR component of STA priority. For example, a higher priority ZE-WuR (or) PCR may have a shorter Window. In other words, the ZE-WuR AP guarantees a short window within which the WuP will be transmitted if a WuP in fact needs transmission. A lower priority ZE-WuR (or) a ZE-WuR that has higher standby capacity may be given a longer Seed window. The ZE-WuR that is lower in priority may have to wait for a longer duration within the Seed window to get its turn for a WuP if necessitated by the ZE-WuR AP. The location and the frequency resources that are allocated to a ZE-WuR may be changed or modified by ZE-WuR AP during any subsequent reassociations or a ZE-WuR Mode modify procedure.

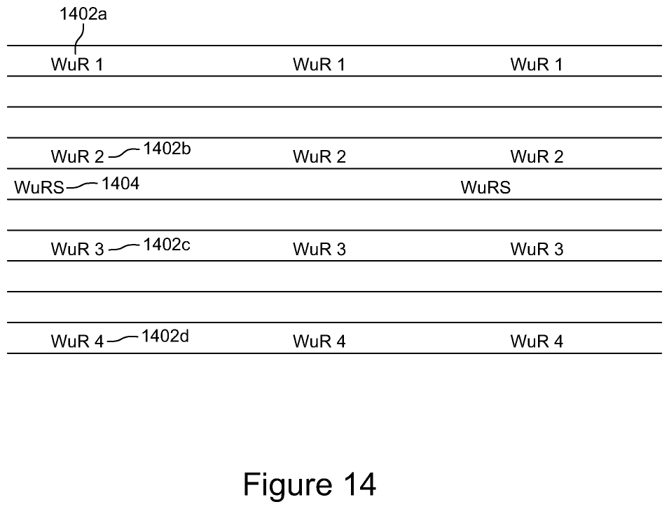

FIG. 14 illustrates exemplary dedicated resources for multi-tone wake-up. As shown in FIG. 14, the ZE-WuR AP determines that the ZE-WuRs 1402a, 1402b, 1402c, and/or 1404d be assigned dedicated resources where their respective WuPs may be transmitted. One or more frequency resources at differing times may be used by the ZE-WuR AP as occasions for transmitting WuPs. In FIG. 14, ZE-WuR 1 1402a refers to the dedicated locations/resources where ZE-WuR 1 may expect to receive its WuP. ZE-WuRS 1404 refers to a common WuP for several, less-capable ZE-WuRs that have restricted frequency use. ZE-WuRS 1404 may be used also as a common WuP for the less-capable ZE-WuRs for performing synchronization and as a group wake-up signature.

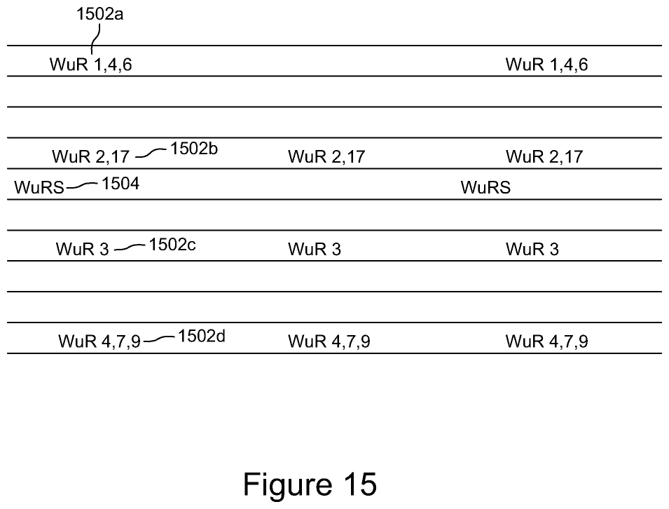

FIG. 15 illustrates exemplary shared resources for multi-tone wake-up. As shown in FIG. 15, the ZE-WuR AP may determine that the ZE-WuRs 1502a, 1502b, 1502c, and 1502d be assigned shared resources where their respective WuPs may be transmitted. One or more frequency resources at differing times may be used by the ZE-WuR AP as occasions for transmitting WuPs to one or more ZE-WuRs 1502a, 1502b, 1502c, and 1502d. In FIG. 15, ZE-WuR 1,4,6 1502a refers to the shared locations/resources where ZE-WuRs 1, 4, and 6 1502a may expect to receive their WuP. The disambiguation of which ZE-WuR is addressed depends on the WuP signature transmitted in those shared resources. As in FIG. 14, ZE-WuRS 1504 in FIG. 15 is a common WuP location for several less capable ZE-WuRs 1502a, 1502b, 1502c, and 1502d that have restricted use of frequency. Note in FIG. 15, ZE-WuR3 1502c may be assigned dedicated resources whereas the other ZE-WuRs 1502a, 1502b, and 1502d are assigned shared resources. Also note that figures indicate a multi-tone scenario where one or more frequency tones are determined by the ZE-WuR AP for transmission of WuP. The associated tone-ZE-WuR pairing may be determined by the ZE-WuR AP in conjunction with requests and capabilities indicated by the STA during ZE-WuR Mode Setup procedures. The ZE-WuRs that have been assigned dedicated resources may be switched to shared resources and vice versa during a subsequence ZE-WuR Mode modify procedure (or) during a reassociation procedure.

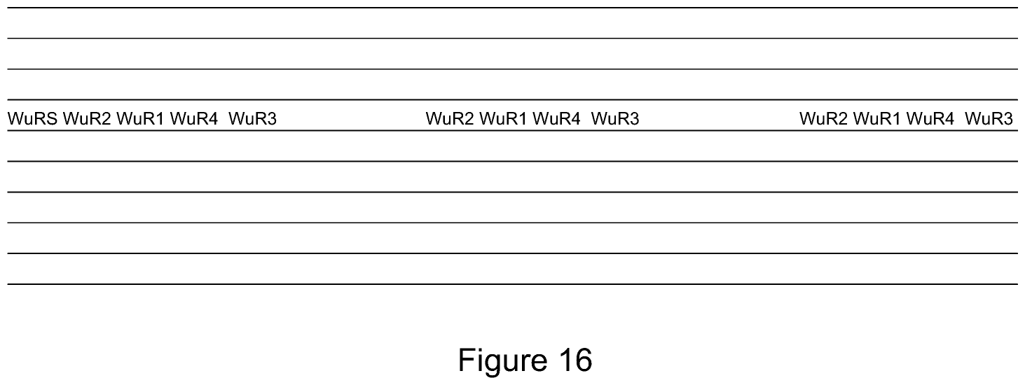

FIG. 16 illustrates exemplary shared resources for single-tone wake-up. FIG. 16 is similar to FIG. 15 except that in single-tone wake-up, the WuP AP supports WuP transmission in just one set of frequency tones.

The WuP AP determines time/frequency resources for enabling wake up functionality in the network. ZE-WuR AP configures the set of time/frequency resources for receiving WuP at each STA requiring wake up functionality. The resources are configured during association and wake up mode setup procedures. The STAs configure their respective ZE-WuR with WuP signatures and the time/frequency resources where the WuP signature may be received.

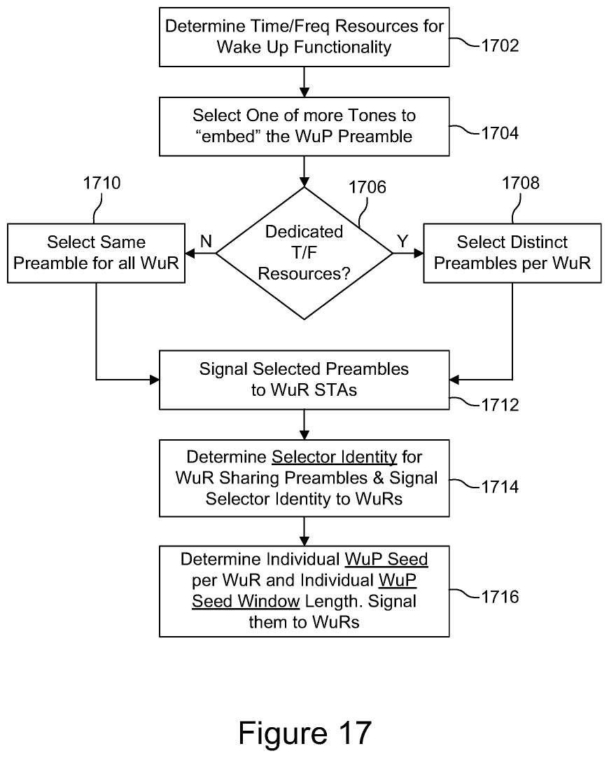

FIG. 17 illustrates an exemplary resource determination for WuP transmissions. As seen in FIG. 17, the ZE-WuR AP determines a need to transmit a WuP to the ZE-WuR. At 1702, the ZE-WuR AP determines the time/frequency resources that have been assigned to the ZE-WuR earlier (via the STA) during association (or) Wake up Mode setup. At 1704, the ZE-WuR AP selects one or more tones to embed the WuP signature. At 1706, if the ZE-WuR had been assigned dedicated resources, at 1708, it selects a distinct ZE-WuR signature out of many pre-configured for the ZE-WuR and transmits the selected WuP for the ZE-WuR.

If the ZE-WuR has been assigned shared resources, then, at 1710, a shared WuP that address one or more ZE-WuRs sharing those resources may be selected. At 1712, the selected preamble may be signaled to the WuR STAs. Note here that the WuP may incorporate a hierarchical scheme to address all or a subset of the ZE-WuRs sharing those resources. At 1714, prior to transmitting the WuP, the ZE-WuR AP determines the Selector identity of the ZE-WuR and determines the hierarchy that needs to be encoded into the WuP signature. A WuP Seed and a WuP Seed window may be configured by the ZE-WuR AP a priori at the ZE-WuR (via STA) during the association and/or wake-up Mode setup procedure.

At 1716, the ZE-WuR may be configured by its STA a wake-up Seed and a Seed Window. Some ZE-WuRs may have a short Seed window while others have longer Seed window lengths.

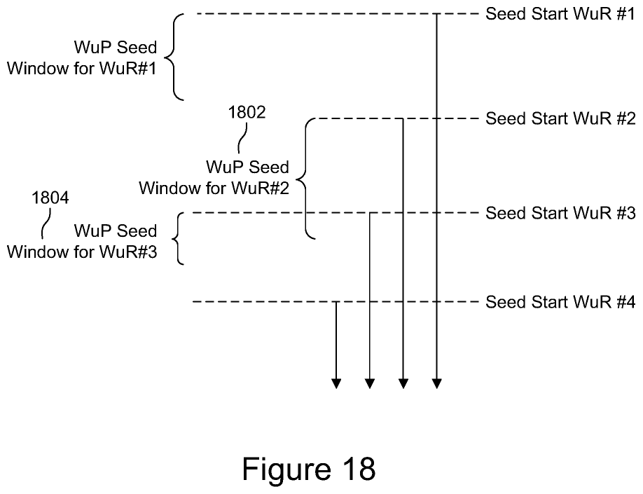

FIG. 18 illustrates seed and seed windows for WuP transmissions. ZE-WuR #3 has a seed window 1804 that may be shorter than for the ZE-WuR #2 seed window 1802 for example. This means, starting with the onset of the WuP Seed indicated for ZE-WuR #3, ZE-WuR #3 may expect to receive its WuP within the expiry of the window which may be significantly shorter than that for ZE-WuR #2. The ZE-WuR AP determines the window length based on latency in channel access due to DCF for example and/or the priority/urgency with which ZE-WuR #3 needs to be woken up. By that same logic, the priority of ZE-WuR #2 may be less (in the exemplary illustration in FIG. 18) meaning STA #2 may be allowed to incur additional delay before a successful wakeup.

While determining resources for WuP transmission, a ZE-WuR AP may leave neighboring tones empty so that power boosting may be applied on tones carrying WuP. Since all WuPs are Type 1 in addition to incorporating an additional Type, a ZE-WuR that correlates a WuP autonomously determines the rate at which its crystal requires disciplining. The ZE-WuR uses WuP signature's preamble clip part of any WuP signature to discipline its clock. In addition to this, if WuP is addressed to itself, ZE-WuR may adjust clock in addition to correlating and decoding the rest of WuP. The ZE-WuR OPT in the WuP enables the ZE-WuR to: (1) partially decode the PHY PDU; (2) fully decode the PHY PDU inclusive of the header less control element; (3) ignore the MAC PDU; or (4) decode the MAC PDU. After this, one of several possible actions are taken by the ZE-WuR using programmed principles one of which is to wake up its PCR. The ZE-WuR's WuP slots may be modified anytime by the ZE-WuR AP during a reassociation or wake-up Mode modify procedure. The ZE-WuR AP may determine such a need to rebalance the network and reassign the dedicated/shared resources for the various ZE-WuRs.

The ZE-WuR AP may determine to power boost the tones carrying the WuP and leave the adjacent tones either with no power or reduced power. The ZE-WuR APs may support power boosting to enable ZE-WuRs that are capable of harvesting energy from receptions of signal with higher energy tones. Through this method, the ZE-WuR APs not only increase the probability of successful reception of WuPs by the target ZE-WuR, the ZE-WuR AP also facilitates energy harvesting by the ZE-WuRs that opportunistically receive the WuP. The ZE-WuR AP may determine the typical response latency and the reason for the response latency when it attempts to wake up a PCR. The ZE-WuR AP initially transmits several WuP (a pack of WuP) to wake up a ZE-WuR. The pack size may be dynamic, may be deployment specific and need not be fixed. The ZE-WuR AP determines the likelihood of subsequent wake-up latency at the ZE-WuR by inferring information transmitted back by the PCR.

Upon reception of the WuP in a WuP pack, the ZE-WuR wakes up the PCR. The ZE-WuR also indicates to the PCR the number of WuPs that it has received so far within the pack. The PCR having woken up estimates the latency in channel access, for example due to DCF. The number of WuPs counted positively within the WuP Pack and the access latency are determined immediately prior to sending of message from PCR to ZE-WuR AP.

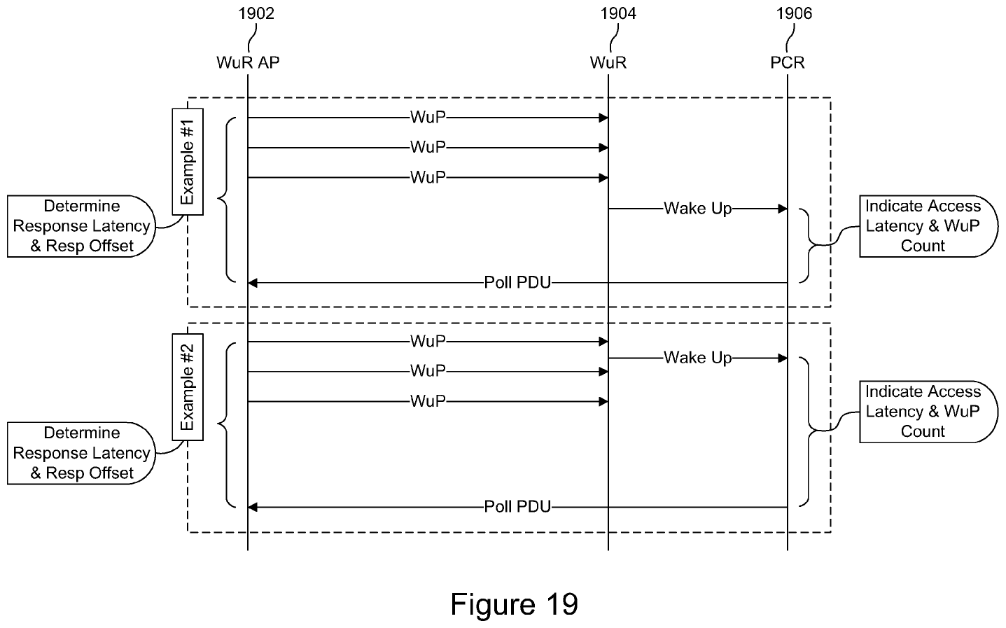

FIG. 19 illustrates how the ZE-WuR AP may estimate receive probability of WuP by a ZE-WuR and the latency/congestion in channel access by the PCR. The ZE-WuR AP 1902, knowing the pack size, determines the Offset from 1st positive decode of WuP by the ZE-WuR 1904 and also latency incurred during channel access. These estimates are performed periodically or opportunistically by the ZE-WuR AP 1902 to fine tune the WuP pack size and the congestion that exists in the system. The ZE-WuR AP 1902 may use this information to rebalance the WuP assignments (such as reducing the group size to WuP assignments) and also to subsequently determine the WuP Pack size to use compared with previous WuP pack sizes.

For example, a WuP that is used to wake up a group of ZE-WuRs may force their respective PCRs to wake up at approximately the same time forcing them to perform channel access to poll the ZE-WuR AP 1902. The larger the group size, the more latency in access for STAs in the group because they may have to perform clear channel assessment/DCF before accessing channel to contact ZE-WuR AP 1902.

In one embodiment, the ZE-WuR AP may receive ZE-WuR capabilities and priority of service requested from the STA during establishment of an association, wake up mode setup, reassociation or wake up mode modify procedures. The ZE-WuR STA requests one or more WuP signatures for wake-up procedures. The ZE-WuR AP may determine the relative priority of the ZE-WuR STA in the system among the various ZE-WuR STAs and determines whether the STA should be granted shared resources or dedicated resources for listening to WuP signatures. In this embodiment, if dedicated resources are assigned to the ZE-WuR STA, one or more WuP signatures are indicated to the ZE-WuR STA. The PCR component of the STA configures the ZE-WuR with assigned WuP Signatures. The ZE-WuR AP uses specific WuP signatures and transmits them on dedicated resources to a ZE-WuR to perform function-specific wake-up of the PCR.

In another embodiment, the ZE-WuR AP assigns shared resources to the ZE-WuR STA during establishment of an association, wake up mode setup, reassociation or wake up mode modify procedures. The ZE-WuR AP may use the same set of resources to transmit a WuP to wake up one or more ZE-WuR sharing those resources. In this embodiment, if the ZE-WuR AP determines to assign shared resources, it also decides to suitable WuP signatures to the ZE-WuRs to minimise group wake up when not necessary. The ZE-WuR AP encodes hierarchical information in the WuP to facilitate shared ZE-WuRs to skip decoding when the hierarchy is broken. The ZE-WuR may be assigned a selector ID and the hierarchy may be encoded as a function of priority among the ZE-WuRs in the group. For example, in a group of ZE-WuRs (1, 3, 5), suppose ZE-WuR 1 is higher priority than both ZE-WuRs 3 and 5 while ZE-WuR 3 is higher priority than 5. The WuP signature encodes a hierarchy which allows ZE-WuR 1 to skip the decode much earlier than ZE-WuR 3 and 5 if the WuP is not addressed to it. In a WuP signature of N bits, suppose the last J bits are used to indicate hierarchy. (N−J) bits are decoded by all ZE-WuRs 1, 3, 5. However, ZE-WuR 1 needs to decode j<=J bits to detect that the WuP is not addressed to it whereas ZE-WuR 3 needs to decode (j+d)<=J bits to detect that the WuP is not addressed to it and finally ZE-WuR 5 needs to decode up to (J+d+e)<J bits to determine that the WuP is not addressed to it.

In a further embodiment, the ZE-WuR AP determines the set of tones that are applied to one or more ZE-WuR over which WuP is embedded for transmissions. The ZE-WuR AP may choose multi-tones to transmit WuP by allocating dedicated frequency resources to each ZE-WuR. The dedicated resources are mapped to each ZE-WuR. The ZE-WuR AP may leave adjacent tones to WuP transmissions for null transmissions. In a following embodiment, the tones that carry WuP are power boosted and the adjacent tones to the WuP tones are transmitted with zero or reduced power. The power boosting may be applied by the ZE-WuR AP to increase reliability of WuP reception as well as to enable energy harvesting by capable ZE-WuRs.

In a related embodiment, the ZE-WuR AP determines the set of tones that are applied to one or more ZE-WuR over which WuP is embedded for transmissions. The ZE-WuR AP may choose multi-tones to transmit WuP by allocating shared frequency resources to various ZE-WuRs. A set of one or more ZE-WuRs may be assigned the same frequency resources over which the WuP may be transmitted to them. The ZE-WuR AP may leave adjacent tones to WuP transmissions for null transmissions. In a following embodiment, the tones that carry WuP are power boosted and the adjacent tones to the WuP tones are transmitted with zero or reduced power. The power boosting may be applied by the ZE-WuR AP to increase reliability of WuP reception as well as to enable energy harvesting by capable ZE-WuRs.

In one embodiment, the ZE-WuR AP may rebalance the ZE-WuRs previously assigned to either dedicated or shared resources to other resources. The ZE-WuR AP may choose to rebalance the ZE-WuRs to use different resources either because of STAs requesting such operation during reassociation or wake-up mode modify procedures or by self-determining a need to rebalance load. The ZE-WuR that had been assigned dedicated resources may be grouped with other ZE-WuRs and a ZE-WuR that was previously grouped may be moved to using dedicated resource. In another embodiment, the ZE-WuR AP configures a ZE-WuR Selector identity on the STA which is subsequently configured by the STA on its ZE-WuR. The Selector ID may be used by the ZE-WuR to determine the hierarchy it may apply while decoding WuPs. In this embodiment, the Selector ID may be assigned to the STA that has been assigned shared resources for receiving WuP. A ZE-WuR that has a selector ID assigned also implicitly determines that it may be part of a group.

In an additional embodiment, the ZE-WuR AP determines the priority of the STA based on parameters exchanged during association requests or wake-up mode request to determine priority of wake-up. In this embodiment, the higher priority STA may be given a shorter window during which it may be guaranteed to receiving a WuP whereas a lower priority STA may be given a longer window during which it may expect its WuP. A nominal seed may be configured by the ZE-WuR AP indicating the potential starting points in time during which the ZE-WuR may become sensitive to WuPs. In this embodiment, a windowed duration indicated by Seed window starting from the seed may be defined to be the timeframe during which the ZE-WuR AP aims to transmit the WuP to appropriate ZE-WuRs.

In 802.11ba, the ZE-WuRs are configured with discovery channel information. The intent of the feature may be to enable a STA to detect the absence of periodic beacons and then seek presence of nearby ZE-WuR APs. In addition to this, even while in service, the ZE-WuR may choose to monitor discovery channels outside of the service period while still associated with a serving ZE-WuR AP. In the proposed solution, the neighbor AP information may be configured as a Discovery packet by the serving ZE-WuR AP to the associated ZE-WuR STAs during association or a Wake-up mode setup procedure. In one embodiment, the ZE-WuR AP coordinates with other APs in the BSS/ESS and assigns one or more WuP signatures to the STAs. The preamble clip may be part of the WuP signature as detailed earlier. One of more preamble clips that are used by the neighboring ZE-WuR APs within a BSS/ESS may be configured at the ZE-WuR by the currently associated ZE-WuR AP. The associated discovery channel with a preamble clip may be included in the discovery packet. The PCR component of the STA configures this information at its ZE-WuR component. This may be a use case for example in offshore oil rigs where there are multiple sea-deployed crest sensors that may arbitrarily float and move over a reasonable overage area that may be serviced by a collection of APs. The floatation may be a form of Brownian movement and arbitrary with the only confines being barriers deployed at the furthest edges of the oilrig boundaries. In such use case, when a sensor moves from one AP's catchment to another AP's catchment, it has no necessity to perform any outstanding duties simply to accommodate the move.

The serving AP could configure a discovery PDU that lists the preamble clips that are used by the other neighboring APs and a movement anywhere within the large area bounded by the barriers. Any arbitrary AP may be able to wake up the sensors if they are configured with the correct preamble clip and with inter-AP coordination.

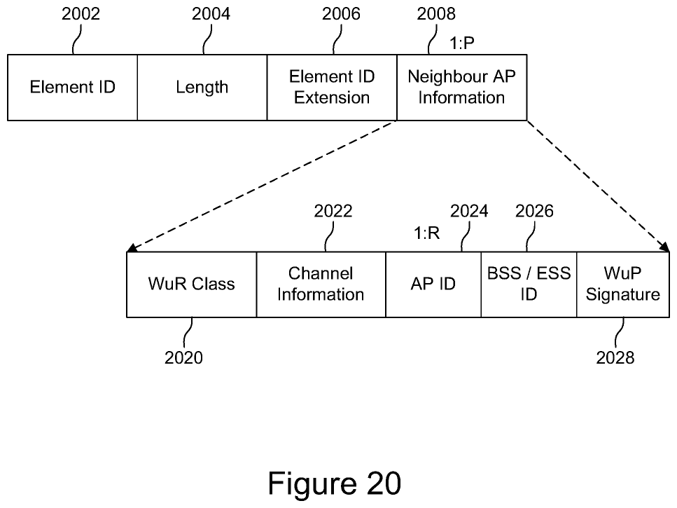

FIG. 20 illustrates an exemplary preamble clip for facilitating ZE-WuR discovery. A packet may include an Element ID frame 2002, Length field 2004, Element ID Extension field 206 and Neighboring AP Information field 2008 (i.e., discovery packet). As shown in FIG. 20, the discovery packet includes a WuR Class field 2020, Channel Information field 2022, AP ID field 2024, and BSS/ESS ID field 2026. It also carries the WuP signatures 2028 that are applicable within the BSS/ESS and signaled to the WuR. Either explicit signatures are assigned, or the associating AP configures seed information for the WuR to derive such information. In one embodiment, the WuP signature carries the preamble clip part and the ZE-WuR Identity assigned specifically to the ZE-WuR by the neighboring APs within the BSS/ESS. One to P such neighbor details per channel information may be configured at the STA. In each channel, from one to R APs that the ZE-WuR may be able to discover is identified in the discovery packet. The STA configures the received discovery packet information at its ZE-WuR prior to entering sleep states.

In another embodiment, the ZE-WuR monitors for the presence of neighboring APs that are detailed in the discovery packet. The ZE-WuR may choose not to monitor WuP from neighboring APs configured in discovery packet if the serving ZE-WuR AP may be deemed to be still serving the ZE-WuR. It may do so by monitoring for beacons and the presence of WuPs, for example. In an embodiment, when the ZE-WuR moves away from its location and into the service area of a different ZE-WuR AP, it uses the previously configured discovery packet information to correlate for WuPs. In that embodiment, having identified an AP on a specific channel, if a WuP signature has been configured for the ZE-WuR previously by the previously serving ZE-WuR AP, the ZE-WuR forgoes a need to associate with the new ZE-WuR AP until a necessity arises in the future. The necessity, for example, may arise when ZE-WuR must wake up its PCR to receive or transmit a data packet.

In another embodiment, when the ZE-WuR discovers itself in the presence of a new AP, it need not re-associate until it is commanded by the new ZE-WuR AP to wake up its PCR. The command to wake up may be performed by reception of a WuP from the new AP but using previously configured information for the ZE-WuR by its previously associated ZE-WuR AP. This may be useful since the PCR may be a less active 802.11 device and requires a wake up only once in several days for transmission or reception of a few packets. In an additional embodiment, once the ZE-WuR receives a WuP from the new ZE-WuR AP, it wakes up the PCR and indicates the AP identity and the WuP as the reason for wake-up. The PCR may re-associate at this time with the new ZE-WuR AP. The newly serving ZE-WuR AP may remove, add or modify the discovery packet configurations at the STA. The ZE-WuR monitors WuP frames during ON windows and may perform scanning only during OFF windows.

In yet another embodiment, the ZE-WuR AP may configure the ZE-WuR with a different type of discovery packet. The ZE-WuR AP indicates neighbor AP information and the relative capacities. The ZE-WuR AP may also indicate admission thresholds of the neighboring APs. One to P neighbor AP information may be configured in a discovery packet at the ZE-WuR. The number of APs that are active in each channel may be also indicated in the discovery packet. The higher the AP count, the higher the probability of finding a neighbor in the indicated channel in the vicinity. However, it may also indicate a reduced capacity at those APs and an increased probability of association rejections. In an additional embodiment, the ZE-WuR AP indicates the Relative Capacity and Admission threshold of each BSSID to the STAs. The Relative Capacity and the Admission threshold of each neighbor information previously provided may be deleted, added or modified by the serving ZE-WuR AP when the PCR may be active. This information may be updated by the serving ZE-WuR WP at the time of Wakeup Mode Setup, update or Beacon transmissions. The Admission threshold refers to threshold below which a candidate AP is likely to reject an Association Request. The threshold may be Boolean signaling a binary “will accept/will not accept” indication to the ZE-WuRs wishing to associate. The threshold may also be configured as a percentage indicating that the Relative capacity must be higher than the Threshold signaled.

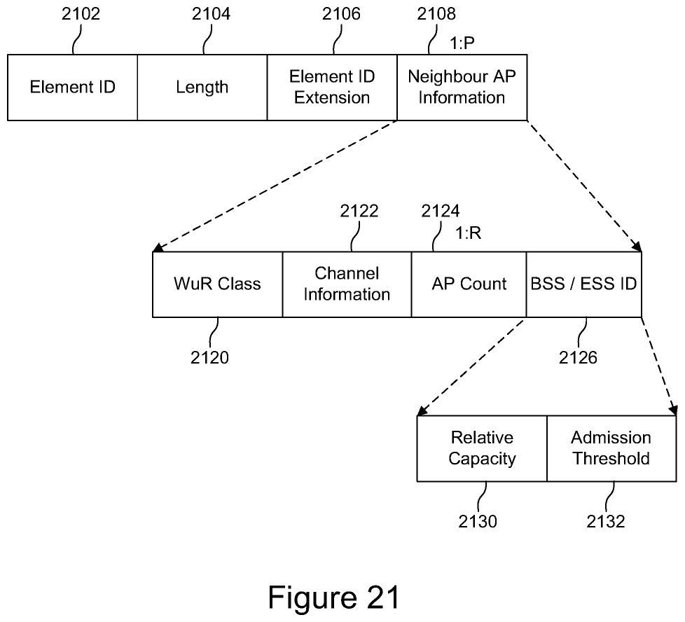

FIG. 21 illustrates an exemplary discovery packet 2108. Similar to FIG. 20, a packet may include an Element ID frame 2102, Length field 2104, Element ID Extension field 2106 and Neighboring AP Information field 2108 (i.e., discovery packet). The discovery packet may include a WuR Class field 2120, Channel Information field 2122, AP ID field 2124, and BSS/ESS ID field 2126. The BSS/ESS ID field 2126 may include a Relative Capacity field 2130 and Admission Threshold field 2132. For example, a relative capacity of 40% and an admission threshold of 10% indicates that the ZE-WuR will likely succeed if an association request is sent towards the AP. Conversely, a Relative capacity of 30% and an admission threshold of 35% indicates that the ZE-WuR will not likely succeed if an association request is sent towards the AP. The ZE-WuR uses the configured discovery packet information to rank candidate APs based on a combination of relative capacity and admission thresholds. Higher ranked APs may be better suitable for channel access in a system that is based on DCF access. The actual candidates for a ZE-WuR would depend on the AP towards which the ZE-WuR is moving towards.

Described below are the enhancements proposed to the 802.11 frame format to enable ZE services effectively, including, power delivery and energy harvesting. It will lay down a conceptual framework for ZE device receivers with battery-less operation, or devices equipped with a small, transient energy storage.

The transient storage may include certain low charge (low capacitance), quick-chargeable, temporary small battery, or other form of energy storage. The problem of a receiver's high-level design and optimal operation may be based on two crucial variables during the receive operation: incident signal strength (power level), and current energy store level (in the transient/temporary storage). The device operation may be characterized in terms of conceptual fundamental thresholds that govern its receiver operation. Depending on the stage of receive processing while receiving a ZE frame and based on the PHY frame structure very similar to that specified in the 802.11ba—WuR spec, an active ZE (WuR) receiver may be in one of two basic states: (1) Signature/Sync Field Detection: Searching/Listening for a ZE sync sequence or ZE signature sequence and (2) Data Frame Decoding/Reception.

The region of operation (ROO) planes associated with each of the states are very similar except for the considered thresholding values and therefore only the ROO plane associated with the first receiver's state is discussed.

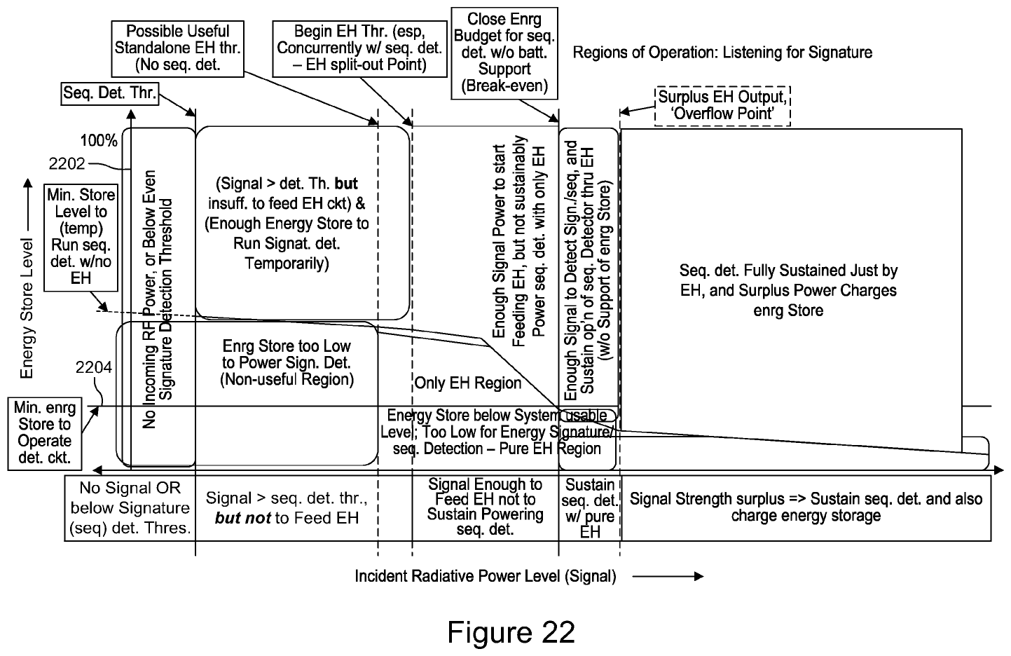

FIG. 22 illustrates exemplary regions of operation for energy harvesting. When a battery-less ZE receiver or one equipped with a small transient energy storage is working in state one, it has power consumption requirements to run its logic circuitry and power collect from incoming signal and feed into the signature(/sync) detector, to reliably detect the signature with a probability of misdetection below a low, pre-set threshold. If power harvested from the incident signal itself is used to power the circuitry, then this incident power may have to be split in some proportion between the detector input port, and the power harvester. The harvesting circuitry could directly supply a transient energy storage, and indirectly power the circuitry. Sequence detection threshold: Assuming that none of the incident power is used to power any receiver circuitry, all of this may be directed into the signature-sequence detector input. One can conceptualize a fundamental threshold on the incoming power, a sensitivity threshold or Sequence detection threshold that may be the minimum signal power level for reliable (as declared by a pre-set criterion) detection of the signature. This may be indicated by a vertical straight line 2202 on the ROO plane in FIG. 22.

Another region is the minimum energy reserve to operate. Even a ‘battery-less’ device may have some form of transient energy/charge storage to power receiver circuitry during the receiver's operation, since the instantaneous harvested energy may not be able to consistently keep up in supplying needed power to [instantaneous harvested energy supply may not be able to consistently keep up with the power need of] the circuitry all through its duration of operation (without this temporary reserve storage). Thus, a minimum reserve level may be needed to maintain in this storage (may also be called an energy buffer) to proceed with any operation of the receiver. This threshold may be the “minimum energy store to operate the signature detector.” This threshold is indicated by a horizontal line 2204 on the ROO plane in FIG. 22.

There may be two soft thresholds on incident signal power, roughly at which energy harvesting from the incident signal may begin. Significant energy harvesting may only be adequately done at signal levels exceeding this threshold with no meaningful or significant energy harvesting achievable at lower signal levels. One such threshold may occur when 100% of the incident power is directed to the energy harvester (this may be referred to as a standalone EH threshold), and another such threshold when EH is run concurrently with the sequence detector. i.e., when more specifically, an amount of power equal to the “Sequence Detection (Sensitivity) threshold” is split out toward the detector input.

Because a well-defined threshold around such a definition may be improbable to visualize, these thresholds might be soft, and may be even embodied by a fuzzy band of power levels. As shown in FIG. 22, these thresholds are vertical lines (dotted) or bands in the plane. Such EH thresholds, as conceptualized in this item may not quite exist; it may be feasible to harvest some energy to varying degrees throughout the full range of input signal levels seen. Another postulation here that should be continuously evaluated and validated is that the EH threshold(s) is greater than the basic signal detection threshold.

Another region is the minimum energy store to run detector with no EH. Near the region where there is only sufficient incident power available to run the signature detector off of (i.e. near the sequence Detection threshold), the ZE receiver idealization may direct 100% of the incident signal power to the detector input. In such a scenario, it may require a sufficient energy store level to power the detector circuits till the end of the detection processing. The minimum level of stored energy required, while operating at an incident signal power level at the Sequence Detection threshold, to successfully run the sequence detector till a reasonable conclusion, may be termed as the threshold of the “minimum energy reserve to run sequence detector with no EH.” The meaning of ‘running the sequence detector till reasonable conclusion’ may be defined as either successfully running the sequence detector for a reasonable amount of time (e.g., to at least detect a full valid signature), or initiating the signature detection processing with reasonable chance to complete the process.

In the region of incident power levels that yield no significant EH (i.e., below the EH thresholds), the minimum energy store level required by the detector operation may gradually (and slowly) reduce as the signal strength increases. This is because higher signal strength may mean more robust, higher confidence, or earlier detection, which may require a lower energy reserve level in the beginning or a stronger signal may ease the processing required to successfully detect sequence, which reduces the power requirements of the processing circuitry; or the probability of successfully detecting the signature increases with less need for retries. Further, the device be able to micro energy harvest even in this region, which reduces the requirement burden on reserved energy stores at the outset of running the sequence detection, as the incident signal strength grows. This threshold is thus close to horizontal, with a slight downward slope on the left side of ROO plane.

Beyond the EH thresholds, the receiver may harvest energy, and any surplus available power from the incident signal may be diverted toward the EH. In the idealized ZE receiver, this works akin to an overflow gate that directs all power up to the sequence Detection threshold toward the detector input, but any power in excess of this threshold gets fully diverted towards the EH circuit. The receiver would hit an operation region where it receives enough incident signal power to balance the power requirement of its circuitry with the surplus energy it may harvest from the incoming signal. This is the threshold where the break-even between energy consumption and capture occurs—it is the point where the receiver may close its energy budget without any assistance from the built-in energy storage.

In the ROO plane, a region where the receiver operates with more-or-less zero balance of surplus energy from its energy harvesting is denoted with a narrow vertical band of incident signal levels. In between the EH threshold and the breakeven threshold of energy sufficiency, the threshold curve that delineates the region where successful sequence detection may proceed would likely be a curved, downward trending arc. Above this arc lies the region where sequence detection may be done with partial dependence on the battery/energy storage, with some energy harvesting. Below this arc is a region where the energy store level may be deemed too low for operating the detector, but which region is useful for pure energy harvesting.

The curve of this threshold may trend sharply downward as the requirement for energy store level may noticeably decrease as more energy becomes available from harvesting as the signal level rises. The final region on the right side of the plane in FIG. 22, where there may be surplus power available from harvesting from the incident signal. Here, the threshold curve bounding below the region could be gently sloping downward, as with increased available power from EH, the receiver may reduce its reliance on the energy storage, and the threshold for the ‘absolute min energy store needed to operate’ may also be lowered as incident power level increases. As the rate of energy supply increases, the energy buffer required may be made slimmer.

Similar to the Sequence Detection state of the ZE receiver, a ROO may be visualized when it is operating in the information/data decoding state. The thresholds for detection sensitivity, in this case decoding sensitivity may presumably be at least somewhat higher than the corresponding threshold for the sequence (signature) detection. Likewise, the EH threshold with concurrent decoding could be a bit offset from this threshold in the state of sequence detection- and possibly be a bit higher in the case of the receiver in the information decoding state.

The signature detector may not rely on any external energy storage, and its threshold for “minimum energy reserve required to operate” could be approximately zero especially due to the special nature of the energy signature sequences outlined above. The EH threshold drawn on this ROO plane in FIG. 22 is for the energy storage used by the data decoder circuitry in the receiver. In this device scenario, this threshold may be indicated by a band of incident signal levels, implying that it indicates a fuzzy range of values rather than an exact threshold. The standard signature detection threshold will not in this case require any stored energy from the main energy store which is kept powering the data decoding operations of the receiver. Hence, this threshold is indicated by the solid line in FIG. 22. However, to make room for a theoretical scenario where battery or temporary storage assistance may be given to signature detector and may perhaps allow it to detect the signature at a lower signal level, a co-threshold to the main signal detection threshold is conceptualized. This is drawn, with a dotted line, to the left (indicating lower incident power) of the main threshold, in FIG. 22

An infrastructure network may include Energy Delivery (ED) nodes, Access Points (APs), and ZE STAs that are members of the network. The architecture could be based on APs (and separate ED nodes, if applicable) connected to the wired infrastructure network (similar to WLAN Distribution System—DS), or a mesh-like architecture, where APs and potentially ED nodes link with each other via wireless “backhaul links.” In most system designs, APs may serve as Energy sources (ED nodes) as well since ED waveforms are sent on the same channel as the information packets. In addition, there may have infrastructure nodes whose sole purpose may be to serve as energy sources. The main rationale for having separate, dedicated ED nodes may be that they may be placed appropriately for more effective energy transfer to certain ZE STAs. In addition, they may engage in beamforming of ED transmissions, either single point beamforming independent of any other transmitting device, or as coordinated beamforming where more than one transmitter coordinates their transmissions to focus the power at intended recipient.

If there are dedicated ED nodes that do not serve as AP for information exchange with non-AP STAs, these may need to exchange control information or signals with the main network, and APs that it needs to work in concert with. In the case where the dedicated ED nodes are connected to the DS wired network all necessary exchange of control signals (e.g., for timing of ED transmissions, identity of intended recipient of ED, etc.) may be exchanged over the DS. There may be an 802.11 mesh architecture, with a set of dedicated ED nodes that are part of the mesh, similar to the mesh APs. When the dedicated ED nodes are part of a mesh architecture, they may communicate with the network over wireless links. That is, no wired backbone connection to the ED node may exist. Modifications in the MAC protocol for communication of the necessary control information from the network to the dedicated ED nodes may be proposed. This essential control information is anything that enables the ED nodes to properly target and time the ED transmissions to intended ZE STA recipients, and time it in relation to the main information communication to those ZE STA.

Single Energy Delivery Source refers to when each ZE STA is served for its EH needs by a single Energy source (ED node). It may be possible to have the same AP that sends information packets to the ZE STA to also serve it for ED. If the ED node for a ZE STA is separate from its information exchange AP, and any dedicated POW frames, waveforms or fields that are part of PHY frames used just for ED need to be sent in a coordinated manner, in time and frequency, with the data packets, then the ED node serving the STA will need to coordinate its ED transmissions with the data transmissions (or receptions) from the AP.

“Multiple Energy Delivery Sources” refers to when any individual ZE STA may be served by multiple ED nodes for its energy harvesting needs. Each ZE STA may have an “active set” of ED nodes that serve it for EH. In a system that allows some mobility, the active set of a ZE STA may be updated time to time. Multiple ED nodes within a ZE STA's active set may participate in coordinated ED to the STA by techniques such as coordinated beamforming of ED signals. It may be also possible to employ a ‘selection of best’ strategy to select an ED node at any time from the active set. Coordinated beamforming may require the participating transmitters to align their waveform's phases precisely, so in addition to aligning their transmission time on the same slot boundary, they may need finer timing alignment that would require a synchronized clock across all these ED node transmitters. This should require pre-arranged transmission start times across all these ED nodes, for the beamformed ED transmissions.

Current frame formats are insufficient for providing the energy required for WUR-Data decoding. Also, the legacy preamble might not be optimal for EH purposes and the WUR-Sync field duration might not be sufficient for meaningful amounts of harvested energy. The WUR might not be able to harvest while trying to detect a WUR frame, i.e., while searching for the WUR-Sync field.

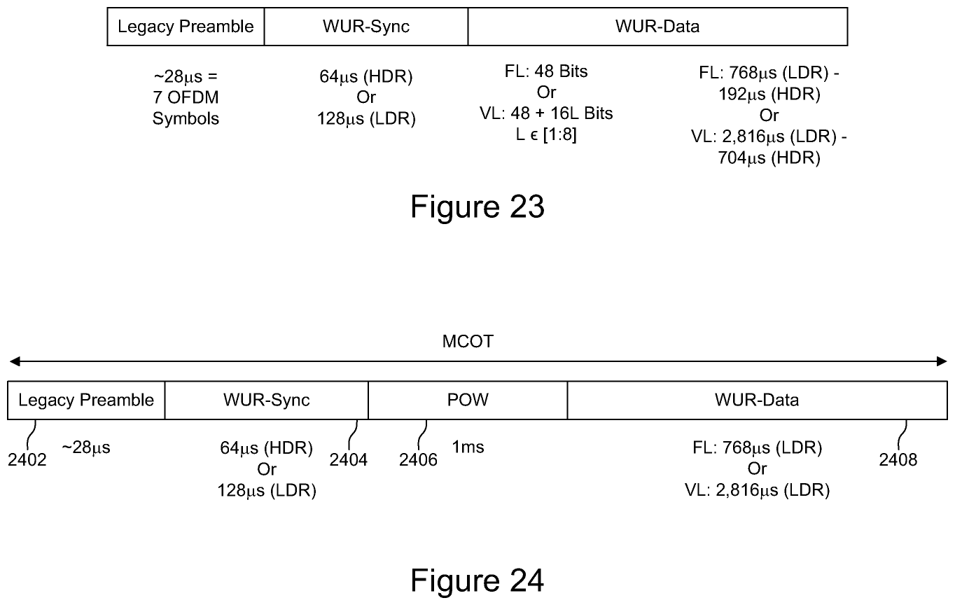

FIG. 23 illustrates the durations of the various fields that include of both fixed length (FL) and variable length (VL) fields. Three different modification options are presented to allow for concurrent delivery of information and energy. Each of these is described above.

FIG. 24 illustrates option 1. In option 1, the frame form includes a Legacy Preamble 2402 and WUR-Sync 2404. The frame form may be modified to include a Power Optimized Waveform (POW) Preamble 2406 after the WUR-Sync 2404. Given an MCOT of 4 ms and maximum WUR frame duration of 2.972 ms, a fixed POW preamble length of ˜1 ms may be accommodated easily. In 802.11, MOOT may be limited by the communication band as well as priority class. In 5 GHz band, MOOT may be limited to 2, 4, or 6 ms only depending on channel access priority class.

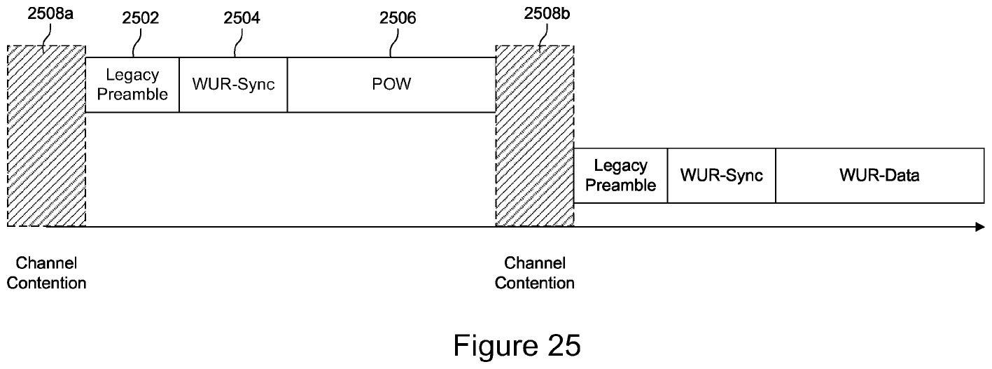

FIG. 25 illustrates option 2. Similar to option 1, the WUR frame may include a Legacy Preamble 2502, WUR-Sync 2504, and POW Preamble 2506. Dedicated EH frames 2508a and 2508b may precede the WUR frames. In one scenario, the AP may contend for the channel at least twice before the delivery of a WUR frame. Contention may be regardless necessary to gain access to the media. In this option, the WUR must retain the harvested energy long enough for the AP to contend for the channel and deliver the WUR frame. Also, under option 2, the WUR frames may be made to have higher access category than EH frames.

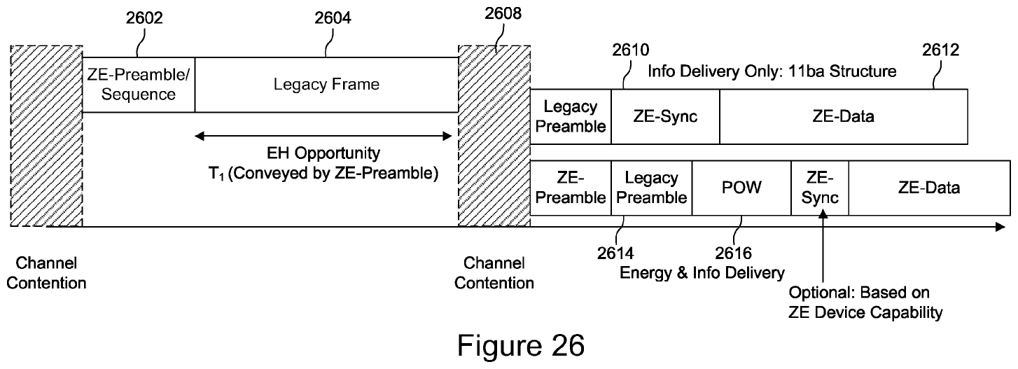

FIG. 26 illustrates option 3. The WUR frame may include a ZE-preamble 2202 and Legacy frame 2604. An EH indication preamble 2608 may be introduced in-precedence/prior to the legacy frames 2604. The AP must contend for the channel at least twice before the delivery of a ZE frame just as in Option 2. The ZE frame may either deliver information only following the legacy IEEE 802.11ba WUR frame structure or deliver both power and information following the proposed frame structure in option 1. Another variant to the frame structure in option 1 is shown in FIG. 26 where a ZE-preamble 2202 precedes the rest of the frame to indicate availability of power delivery for a certain duration, e.g., the duration may be indicated by the preamble itself, before the fields delivering information to the WUR. Further, the ZE-data field 2612 may be immediately preceded by a ZE-Sync 2610 to ensure synchronization for correct information decoding as in FIG. 26. The new variant of the ZE-frame structure enables concurrent delivery of information & energy where the ZE-Sync 2610 may be optional based on device's synchronization capability, e.g., using the ZE-preamble 2602, and its need for re-synchronization after a duration which might be less than the overall duration of the legacy preamble 2614 and POW 2616.

When designing a WUR-sync or a ZE-preamble for “harvest or detect” and/or “harvest then detect/decode” architectures, two broad designs may be considered. In one design, the existing WUR-Sync design may be not changed which may potentially have some negative impacts on the legacy/existing WUR architectures. Whereas in a second design, changes are introduced to the existing WUR-sync leading to more efficient integration with legacy/existing WURs.

In one embodiment, no change may be necessary to the legacy WURs. However, legacy WURs may detect a WUR frame, which contains the new power delivery field, but fail to decode the data field within the frame. On the other hand, new WURs will be able to detect the new WUR frame, harvest energy, then decode the data field. The new WURs, however, may still fail to decode any legacy WUR frames that do not include the power delivery field with the POW. Under this design, the onus may be on the AP to handle the differentiation between legacy and new WURs and generate/transmit the corresponding WUR frame accordingly. The drawback of such an embodiment is that the power consumption overhead associated with decoding additional WUR frames not intended for the WUR.

In another embodiment, a new WUR-Sync design may be considered where legacy WURs do not detect the Energy Harvesting frame (e.g., a dedicated frame for energy harvesting or a WUR frame that contains the new power delivery field) and new WURs may differentiate between legacy and new WUR frames. This embodiment may subsequently lead to power consumption savings due to the WURs' capability to ignore data decoding when not needed/intended for itself.

Given the new WURs' capability to differentiate between a WUR frame dedicated for power delivery/energy harvesting versus a WUR frame intended for concurrent delivery of power and information versus information only. The new WUR may have the liberty to choose between missing an energy harvesting opportunity or information decoding opportunity based on its battery's current charge level.

A potential WUR-sync design may be to utilize current IEEE 802.11ba WUR-Sync code structure with a base sequence S followed by its complement of (1-S). The obvious advantage of this method may be that the transmission capability may be supported with minor modification and the WURs will still be capable of using a single correlator. The disadvantage may be that legacy WURs might mistakenly interpret the second negative peak as an HDR WUR frame if first positive peak is not considered. This may force a modification to the detection circuitry or become a requirement for legacy WURs. Without this modification, legacy WURs may end up consuming more power during EH frame transmissions.

For the ZE devices, viability of sustained communication depends on energy regulation. It may be foreseeable, even in existing architectures, to use supplementary and alternative energy sources to sustain electronic functions with a circuitry. However, cost may be an important factor that limits the alternatives/redundant mechanisms that may be built in. In one architecture, instead of relying on alternative sources, it may rely on additional reserves. When energy is harvested, it is placed in an energy store that retains capacitance for a longer duration in time. Even when energy is not expended, capacitors drain energy at some nominal rates depending on the quality of electronic components.

Thus, when energy harvesting rate is very high, energy store may not be sufficient so as to require a supplementary store. In one architecture, two different energy stores (batteries) may be used—one that is nominally used for e.g., decoding of info, and another that is much smaller capacity that the nominal storage. The second may be termed as auxiliary storage. The auxiliary store may charge very quickly and may be dedicated to sequence detector only since it is the highest priority task in an architecture and the most common procedure to execute. The auxiliary store may be a device that presents very high input impedance. As detailed in earlier sections, Energy signature may include sufficient POW structure to enable signature (sequence) detection and this may be performed without help of other battery. This may be sufficient to help simultaneously charge the sequence detector's energy store for detecting itself or, the signature sequence could be prefixed by short a POW to help charge up the store used for sequence detection.

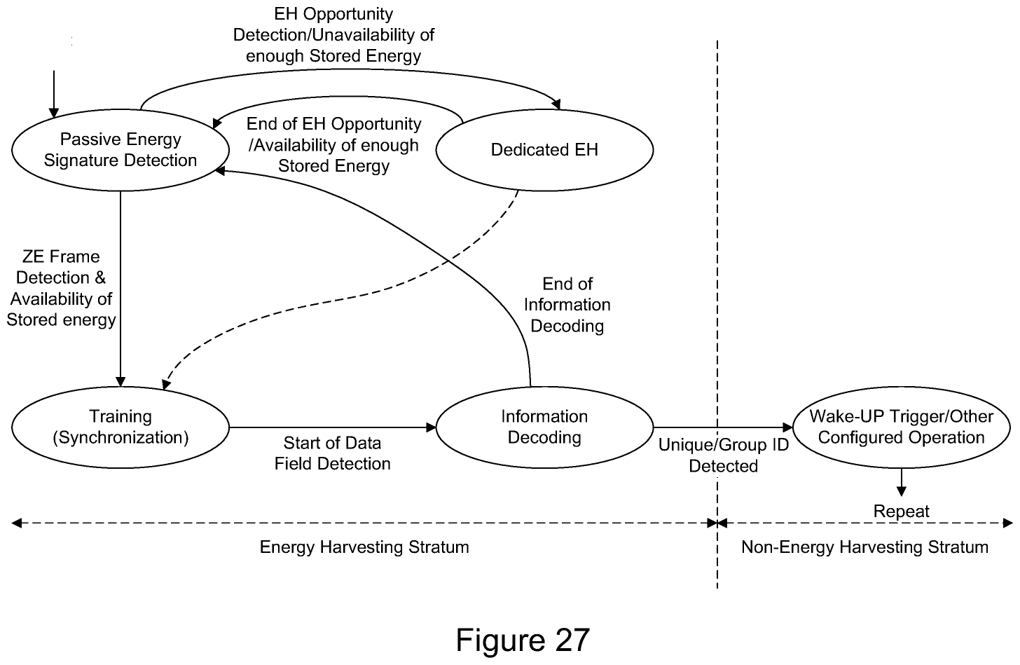

Though the implementation details may be various, it may be useful to visualize the harvesting scheme as a state machine implementation. Broadly, the two may be considered in two levels: (1) energy harvesting level and (2) non-Energy harvesting level. FIG. 27 illustrates energy harvesting and non-energy harvesting levels.

As shown in FIG. 27, in the non-energy harvesting level, there may be sufficient storage and thus, detection of the sequence may be automatic. In the Energy harvesting level, there are sub-states to enter into depending on whether there is sufficient availability of unavailability of stored energy.

It may be important to calculate the capacity of a rechargeable battery for a deployment scenario, i.e. device battery life. Current state of the art on rechargeable battery technology are dependent on battery's self-discharge characteristics, Loading characteristics in charging mode as well as recharging characteristics. Additionally, current state of the art on boost type DC-to-DC converters may be dependent on input voltage range, boost ratio and output load capability. To design ultra-low-power circuits, it may be important to consider leakage current characteristics. This may involve determining rechargeable battery capacity requirement (e.g. 100 mAh), defining the goal due to a single recharging POW transmission assuming the POW is received with sufficient strength, i.e. 1-5% improvement of the current battery state, selecting potential differences needed for effective charging such as calculating the size of a capacitor at the input of the DC-to-DC converter and calculating the duration of the single POW transmission and number of required transmissions for different link distances.

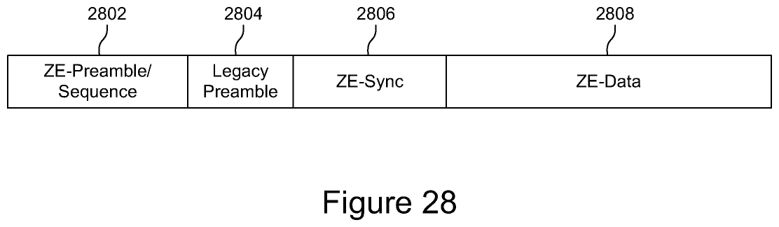

FIG. 28 illustrates an exemplary embodiment of a first frame format for energy harvesting. As shown in FIG. 28, a ZE-preamble 2802 sequence may be transmitted and followed by the legacy preamble 2804 that may be comprehendible by all 802.11 legacy devices and used for synchronization and training. This pair may be followed by the ZE-Sync field 2806 and the ZE-Data fields 2808. In one alternative, the legacy preamble 2804 and ZE-preamble 2802 may be interchanged as it will not affect the behavior expected. The ZE-preamble 2802 in this design may be intended for the indication of a WUR frame presence as well as for the delivery of power when needed.

This design is then another variant of the design discussed above with the POW field moving to the beginning of the frame as a ZE-preamble/sequence which may be generated as an energy signature. The power consumption associated with energy signatures detection may be negligible compared to that associated with ZE-Sync/WUR-Sync detection and data decoding. This frame format may then be helpful in several scenarios.

In one embodiment, a WUR/ZE-STA with a strong received signal strength may be interested in harvesting energy before attempting to decode data but has tight synchronization requirements forcing a need for a synchronizing sequence (ZE-Sync) right before the data field.

In another embodiment, a WUR/ZE-STA may have independent ambient energy harvesting circuitry and tight synchronization requirements. Therefore, it does not need an indication of presence of an energy harvesting opportunity but does need a synchronizing sequence (ZE-Sync) right before the data field.

In another embodiment, a WUR/ZE-STA may have a weak received signal strength which is not sufficient for energy harvesting but is sufficient for information decoding. The WUR then may need to only detect the ZE-Sync and perform data decoding without attempting to harvest energy.

A first frame format may be exemplified in a station (STA) with exchanging capability (e.g., battery type, device class, RF frontend structure) and configuration (e.g., assigned signatures and mapping to EH windows durations based on supported operation regions) with the AP-STA. The STA may transition to passive energy signature detection state and detect the presence of a ZE frame with a First Format. On a condition that a stored energy level above a first threshold and a received signal strength above a second threshold are determined based on a current region of operation, the STA may transition to the training and synchronization state and subsequently the information decoding state. On a second condition that a unique or group address identifier is detected, the STA may send a wake interrupt to the main transceiver and exchange information with AP-STA.

The first and second thresholds may either be fixed values or functions of received signal strength and energy storage level, respectively. In another alternative when the first condition is not satisfied, the STA may continue monitoring the channel for energy signatures and/or continue energy harvesting. In an additional alternative, on a second condition that a unique or group address identifier is detected, the STA may use backscattering to exchange information with the AP-STA.

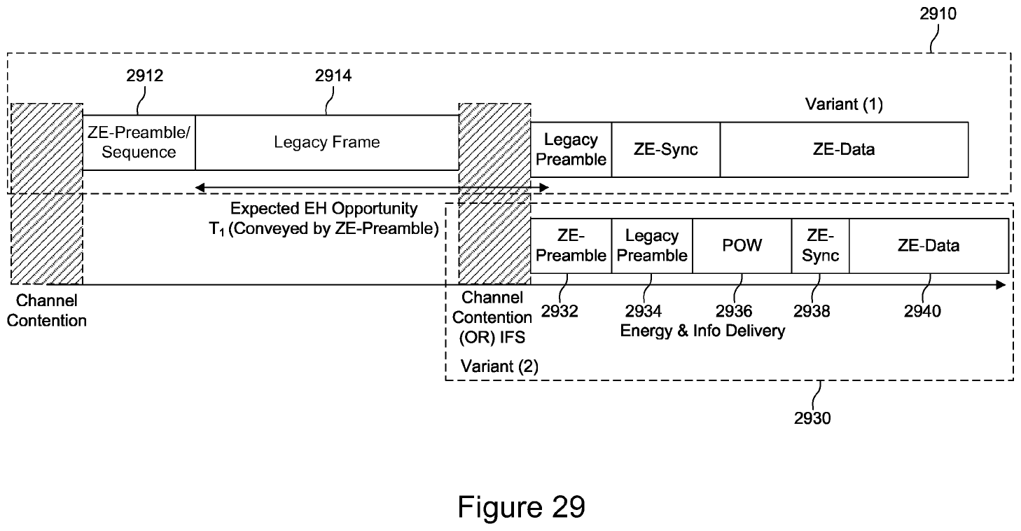

FIG. 29 illustrates a second frame format for energy harvesting. FIG. 29 illustrates a first exemplary embodiment 2910 and second exemplary embodiment 2930. In the first exemplary embodiment 2910, a ZE-preamble 2912 may be transmitted to inform the ZE devices of an energy harvesting opportunity. In some embodiments, the transmission may be intended for multiple ZE-devices and may be received by a ZE-device for which the transmission was not intended (i.e., a non-intended STA overhears a transmission meant for another STA). The legacy frame 2914 may be energy bearing to at least some of the ZE devices and the duration of the energy harvesting opportunity may be indicated in the ZE-preamble 2902. This fits in well within the existing framework because any access to the media is based on contention or a delay for an IFS period. The first exemplary variant 2910 shows the ZE device performing EH during an EH opportunity from a legacy frame. Once that is complete, the ZE devices participate in data communications. This is one example of concurrent energy and information transfer.

In a second embodiment 2930 of the frame format, a dedicated opportunity to transmit a Power Optimized Waveform (POW) 2936 may be provided right after the preambles 2932 and 2934. Just as in the first frame format, the ZE preamble 2932 and legacy preamble 2934 may be switched in location. However, the POW 2936 follows immediately after the preambles 2932 and 2934 and this is indicated as so in the preambles 2932 and 2934. Following that POW 2936, the ZE device harvest sufficient energy to participate in information transfer which is shown with ZE Sync 2938 and Data fields 2940.

A second frame format may be exemplified in a STA with exchanging capability (e.g., battery type, device class, RF frontend structure) and configuration (e.g., assigned signatures and mapping to EH windows durations based on supported operation regions) with the AP-STA. The STA may transition to signature detection state, detecting presence of a ZE frame with a second format, and determining current operation region. On a condition that the current operation region is determined to be the same as the last reported region, the STA may determine the duration of the energy harvesting (EH) window based on a detected signature and operation region. On a condition that a first operation region is determined current, the STA may utilize a first battery type (battery type 1) to power training, synchronization, and decoding states. The STA may then transition to the training and synchronization state at the end of the determined EH window duration. The STA may then transition to an information decoding state based on the detection of a known SYNC sequence. On the detection of a unique or group address identifier, the STA may send a wake interrupt to the main transceiver and exchanging information with AP-STA.

In another exemplary embodiment, a second frame format may be exemplified in a STA with exchanging capability (e.g., battery type, device class, RF frontend structure) and configuration (e.g., assigned signatures and mapping to EH windows durations based on supported operation regions) with the AP-STA. The STA may transition to signature detection state and detect the presence of a ZE frame with a second format, and determine current operation region. On a condition that the current operation region is determined to be the same as the last reported region, the STA may determine the duration of the EH window based on detected signature and operation region. On a condition that a second operation region is determined current, the STA may transition to the dedicated EH state to charge a second battery type (battery type 2) for the determined duration. The STA may transition to the training and synchronization state at the end of the determined EH window duration and utilizing battery type 2's energy. The STA may transition to a information decoding state based on the detection of a known SYNC sequence and utilize battery type 2's energy. On the detection of a unique or group address identifier, the STA may send a wake interrupt to the main transceiver and exchange information with AP-STA.

In another exemplary embodiment, a second frame format may be exemplified in a STA with exchanging capability (e.g., battery type, device class, RF frontend structure) and configuration (e.g., assigned signatures and mapping to EH windows durations based on supported operation regions) with the AP-STA. The STA may transition to signature detection state and detect the presence of a ZE frame with a second format, and determine current operation region. On a condition that the current operation region is determined to be the same as the last reported region, the STA may determine the duration of the energy harvesting (EH) window based on detected signature and operation region. On a condition that a third operation region is determined current, the STA may transition to the dedicated EH state to charge battery type 2 for a fraction of the determined duration and battery type 1 for the rest of the determined duration based on the received signal strength. The STA may transition to the training and synchronization state at the end of the determined EH window duration and utilizing battery type 2's energy. The STA may transition to a information decoding state based on the detection of a known SYNC sequence and utilize battery type 2's energy. On the detection of a unique or group address identifier, the STA may send a wake interrupt to the main transceiver and exchange information with AP-STA.

The efficiency with which the battery stores are usable in a deployed system depends on the energy harvesting capabilities. Some of this capability may be built in to avail opportunistic energy sources while the others are based on dedicated energy harvesting. The opportunistic methods do not interfere with other procedures such as procedures for data communications. The STAs use opportunistic situations to augment their energy store.

In another embodiment, a STA utilizes opportunistic EH opportunities to determine the need for dedicated EH opportunities. Here, the STA may have an exchanging capability (e.g., battery type, device class, RF frontend structure) and configuration (e.g., assigned signatures and mapping to EH windows durations based on supported operation regions) with the AP-STA. The STA may transition to a passive energy signature detection state and detecting presence of an energy harvesting (EH) opportunity. The STA may determine the duration of the EH opportunity based on the detected energy signature or as a fixed preconfigured value. The STA may perform pure EH for the determined duration and transitioning back to passive energy signature detection state at the end of that duration. The STA may periodically (or based on a configured event detection), report EH quality and/or request dedicated EH signaling configuration.

In some instances, the energy harvesting may be based on coordination amongst non-AP STAs in an ad-hoc architecture. In these instances, multiple STAs might be equipped with higher capacity batteries or directly connected to the power grid and therefore may deliver power to other STAs both types of STAs as ZE-STAs are denoted.

In one embodiment, a STA may perform ad-hoc energy harvesting by sending a measurement occasion configuration to the ZE-STA, e.g., a configured preamble that is followed by an energy measurement occasion (a generic transmission from a nearby STA) after an expected configured duration. The STA may then receive a measurement report for one or more occasions, e.g., via a supported backscattering transmission. The STA may then determine a suitable STA for the delivery of energy to the ZE-STA, e.g., the STA with the highest measured energy level. The STA may transmit a query request (or a newly defined energy delivery request of a specific duration) to the determined STA preceded by a preamble/energy signature that is known by the ZE-STA. The STA may repeat the query request until an active period of query response transmission is achieved based on the considered preamble/energy signature.

In support of hierarchical, sequence-based signaling, STAs may exchange capability (e.g., receiver architecture and correlators hierarchy configuration) and additional configuration (such as mapping between identifiers/functions and WuP sequences/energy signatures, assignment of a set of unique and/or group identifiers) with the AP-STA as explained in earlier sections. Based on the one or more preambles assigned to the STA, the STA may detect a preamble corresponding to associated AP's identity, e.g. BSSID, in a first level of hierarchy. Note that the AP may also encode second level hierarchical information into the signature. STA in that case may require transitioning to a second level of correlation hierarchy to look for any of the assigned identifiers. On a condition that a unique/group identifier is detected, the STAs may transition to a third level of correlation hierarchy. This method allows the AP to perform hierarchical wake up of STAs and in turn allows the STAs to terminate early a decode procedure if a mismatch occurs at one hierarchy.

The STAs detect a sequence corresponding to a specific operation/function, e.g. sensory measurement or a main transceiver wakeup or MAC payload decoding. As detailed earlier, the AP and STAs may agree upon multiple function specific wake-up signatures and the hierarchical addressing becomes very useful. Importantly, those STAs that are not addressed by a specific Wake-up signature may use transmissions made to other STAs for energy harvesting.

In an exemplary embodiment, a STA may reduce power operation cost via a configurable hierarchical correlation function by exchanging capability (e.g., receiver architecture and correlators hierarchy configuration) and configuration (e.g., mapping between identifiers/functions and WuP sequences/energy signatures, assignment of a set of unique and/or group identifiers) with the AP-STA. The STA may detect a preamble corresponding to associated AP's identity, e.g., BSSID, in a first level of hierarchy and then transition to a second level of correlation hierarchy to look for any of the assigned identifiers. On a condition that a unique/group identifier is detected, the STA may transition to a third level of correlation hierarchy. The STA may detect a sequence corresponding to a specific operation/function, e.g., sensory measurement or a main transceiver wakeup or MAC payload decoding. The STA may execute the detected function or operation.

In another exemplary embodiment, a STA may receiving a Wake-up command and defer the Wake-up procedure until a pre-determined event and/or an opportunistic event. The STA may detect the identity of the transmitting node from the wake-up sequence. The STA may detect the identity of the transmitting node as infrastructure service set from the wake-up sequence. The STA may detect if a mobility event has occurred based on the received wake-up sequence. The STA may determine the decoding of the wake-up sequence earlier based on hierarchical partial decoding.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a station (STA), the method comprising:
receiving, during an energy detection state, a zero energy (ZE) frame from an access point (AP) that indicates a presence of an energy harvesting (EH) window;
harvesting energy for a determined time duration during the EH window; and
receiving a data portion of the ZE frame based on a current stored energy of the STA being above a first threshold and a signal strength of the received ZE frame being above a second threshold.

2. The method of claim 1, wherein the EH window is indicated by a ZE preamble.

3. The method of claim 1, further comprising:
on a condition that the STA detects a group ID, initiating an uplink access attempt with the AP.

4. The method of claim 1, wherein a duration of the EH window is indicated by a signature.

5. The method of claim 1, wherein the received ZE frame is a frame intended for another STA.

6. The method of claim 1, wherein the harvested energy is used to determine whether the STA has sufficient stored energy to receive the data portion of the ZE frame.

7. The method of claim 1, wherein the current stored energy is stored in a capacitor.

8. A station (STA) comprising:
a receiver;
a transmitter; and
a processor,
wherein the receiver is configured to receive, during an energy detection state, a zero energy (ZE) frame from an access point (AP) that indicates a presence of an energy harvesting (EH) window;
wherein the processor is configured to harvest energy for a determined time duration during the EH window;
wherein the receiver is further configured to receive a data portion of the ZE frame based on a current stored energy of the STA being above a first threshold and a signal strength of the received ZE frame being above a second threshold.

9. The STA of claim 8, wherein the EH window is indicated by a ZE preamble.

10. The STA of claim 8, wherein on a condition that the STA detects a group ID, the processor is configured to initiate an uplink access attempt with the AP.

11. The STA of claim 8, wherein a duration of the EH window is indicated by a signature.

12. The STA of claim 8, wherein the received ZE frame is a frame intended for another STA.

13. The STA of claim 8, wherein the harvested energy is used to determine whether the STA has sufficient stored energy to receive the data portion of the ZE frame.

14. The STA of claim 8, wherein the current stored energy is stored in a capacitor.

15. A method performed by a station (STA), the method comprising:
receiving, during an energy detection state, a zero energy (ZE) frame from an access point (AP) that indicates a delivery of a power optimized waveform;
harvesting energy for a determined time duration during the delivery of the power optimized waveform; and
receiving a data portion of the ZE frame based on a current stored energy of the STA being above a first threshold and a signal strength of the received ZE frame being above a second threshold.

16. The method of claim 15, further comprising:
on a condition that the STA detects a group ID, initiating an uplink access attempt with the AP.

17. The method of claim 15, wherein the received ZE frame is a frame intended for another STA.

18. The method of claim 15, wherein the harvested energy is used to determine whether the STA has sufficient stored energy to receive the data portion of the ZE frame.
